(19) United States
(12) Patent Application Publication
(10) Pub. No.: US 2023/0325735 A1
(43) Pub. Date: Oct. 12, 2023

(54) GENERATING AND PROCESSING CONTEXTUALIZED GROUP DATA

(71) Applicant: MICROSOFT TECHNOLOGY LICENSING, LLC, Redmond, WA (US)

(72) Inventors: Aleksander TORSTENSEN, Nordre Follo (NO); Arve Aleksander Nymo SKOGVOLD, Trondheim (NO); Xin DING, Trondheim (NO); Aleksander ØHRN, Oslo (NO); Jeanine LILLENG, Trondheim (NO); Joel Njoroge MBUGUA, Nairobi (KE); Jakob WERNER, Oslo (NO); Stanislaw Jan WILCZYNSKI, Wroclaw (PL); Andreas EIDE, Oslo (NO); Joyce LIN, Lorenskog (NO); Vikramjeet Singh JASSAL, Lorenskog (NO); Vladislav TROTSENKO, Trondheim (NO); Lene Christin RYDNINGEN, Berlin (DE); Jørgen Vinne IVERSEN, Trondheim (NO); Polly NINCEVIC, Oslo (NO); Cyhana Lena WILLIAMS, Oslo (NO); Vushesh Babu ADHIKARI, Trondheim (NO); Øystein TORBJØRNSEN, Trondheim (NO); Elias AAMOT, Trondheim (NO); Nico REIßMANN, Trondheim (NO)

(21) Appl. No.: 17/704,801

(22) Filed: Mar. 25, 2022

(51) Int. Cl. G06Q 10/06

(52) U.S. Cl. CPC G06Q 10/063118

(57) ABSTRACT

Technology is disclosed for controlling the processing and presentation of group data on computing devices to provide improved computing applications, electronic communications, and user computing experiences. Data indicating a group of people may be programmatically determined or inferred, such as from the user activity of a particular user. Group data characterizing the group of people may be generated and contextualized or personalized for the user based on a user context or intent. Aspects of the contextualized group data may be provided to the user in response to an interaction with an indication of the group or group member. The group data may be provided as a set of group information items, and further may be formatted or assembled for presentation based on the user context, and/or may be consumed by a computing application or service to provide an improved user computing experience.

### BACKGROUND

Personal computing devices, such as laptops, computers, and smartphones, now carry and display a great variety of information and are used in a variety of settings. In turn, a variety of people may be encountered through these computing devices. Using these personal computing devices, people spend significant time in meetings (and increasingly online meetings) and communicating with other people, including time collaborating or working with teams or groups of people. In these meetings, collaborations, and communications, it can be helpful to have information presented about the group of people that is contextual with respect to a user interacting with that group. For example, when a user has a meeting with or communicates with a team, it would be helpful to provide the user with information about the team that is relevant to the user and/or the meeting. Similarly, it would be helpful to provide new employees, or other users who are unfamiliar with a particular group, with contextual information about that group so that those users’ interactions with the group are more effective or efficient. However, existing conventional technologies lack computing functionality to determine and provide contextual data characterizing aspects of a group of people with respect to a user, nor does there exist computing functionality for using such data to provide improved computing applications and an improved user computing experiences.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments described in the present disclosure are directed towards technologies for improving electronic-communications computing applications and user computing experiences on user computing devices (sometimes referred to herein as mobile devices or user devices). In particular, this disclosure provides technologies to programmatically determine a group of people and to further generate or determine data, for providing to a particular user, that characterizes aspects of the group of people. The data that characterizes the group of people may be contextualized or personalized for the particular user based on, for example, data about the user, such as contextual data indicating the user’s intent for interacting with the group of people. Aspects of the group data may be provided to a user in response to the user interacting with the group or an indication of the group. Further, the group data may comprise a set of one or more information items about the group and may be formatted for presentation to the user via a graphical user interface (GUI) element, such as a modified Live Persona Card (LPC) that depicts specific information items about the group that are relevant and/or contextualized for the user.

In some embodiments, the operation of a computer application, such as a communications application, may be configured or modified to execute computer instructions for presenting a GUI element comprising the set of group information items (or a portion thereof) in response to a user interacting with the group, or an indication of the group, via the computing application. The group data may be assembled into a data structure associated with the group or group members, and may also be used for the provisioning of new communication application functionality and/or for displaying aspects of the group data on a user device based upon a context of a viewing user. Such technologies improve the user experience in any of a number of computer applications and platforms.

### BRIEF DESCRIPTION OF THE DRAWINGS

Aspects of the disclosure are described in detail below with reference to the attached drawing figures, wherein:

FIG. 1 is a block diagram of an example operating environment suitable for implementations of the present disclosure;

FIG. 2 is a diagram depicting an example computing architecture suitable for implementing aspects of the present disclosure;

FIG. 3 illustratively depicts an exemplary schematic screenshot from a personal computing device showing aspects of an example graphical user interface, in accordance with an embodiment of the present disclosure;

FIG. 4 illustratively depicts an exemplary schematic screenshot from a personal computing device showing aspects of an example graphical user interface, in accordance with an embodiment of the present disclosure;

FIGS. 5A-5C illustratively depict exemplary schematic screenshots from a personal computing device showing aspects of example graphical user interfaces, in accordance with an embodiment of the present disclosure;

FIGS. 6 and 7 depict flow diagrams of methods for programmatically determining group data and processing such data based on a context, in accordance with an embodiment of the present disclosure;

FIG. 8 is a block diagram of an example computing environment suitable for use in implementing an embodiment of the present disclosure; and

FIG. 9 is a block diagram of an example computing environment suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, such as to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-useable instructions stored on computer storage media. The methods may be provided by a stand-alone application, a service or hosted service (stand-alone or in combination with another hosted service), or a plug-in to another product, to name a few.

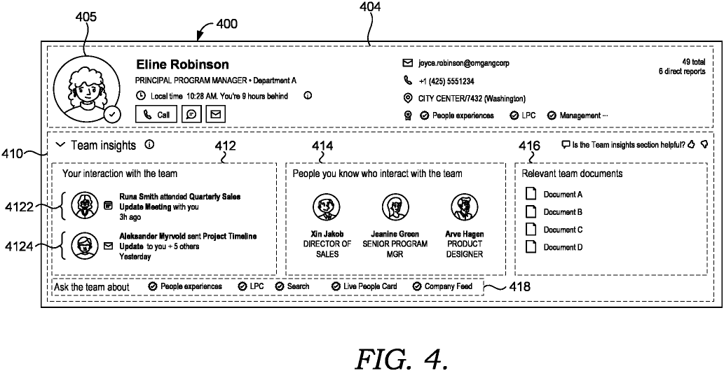

Aspects of the present disclosure relate to technology for improving electronic communication technology and enhanced computing services for a user, based on contextualized data characterizing aspects of a group of people. In particular, the solutions provided herein include technologies to programmatically determine a group of people and further determine or generate group data that characterizes aspects of the group of people, and for providing the data to a particular user. The group data that characterizes aspects of the group of people may comprise a set of one or more information items and can be contextualized or personalized for the particular user, who may be interacting with or querying the group, based on, for example, data about the particular user. The information items or other group data (or a portion thereof) may be assembled and formatted or prepared for presentation to the user via a graphical user interface (GUI) element, such as a Live Persona Card (LPC) or other user profile, which may be modified to depict information items about the group that are relevant and/or contextualized for the user viewing the LPC. One example of such a GUI element is further described in connection with FIG. 4.

In some embodiments one or more categories of group data may be presented to the user. For example, and without limitation, categories of group data that may be presented to the user may comprise: information regarding interactions between the user and the group, such as past communications to one or more group members and to the user or meetings attended by one or more group members and the user; shared connections of people between the user and the group, such as people known by the user and one or more group members; relevant documents, such as documents about the group or related to the group that may be relevant to the user; and/or other insights or information about the group that may be relevant to the user, such as group interests, experience(s), areas of expertise, office location(s), or other information characterizing an aspect of the group. The specific group information items in these categories or another category may be programmatically generated or otherwise determined for relevance to the user, as described herein.

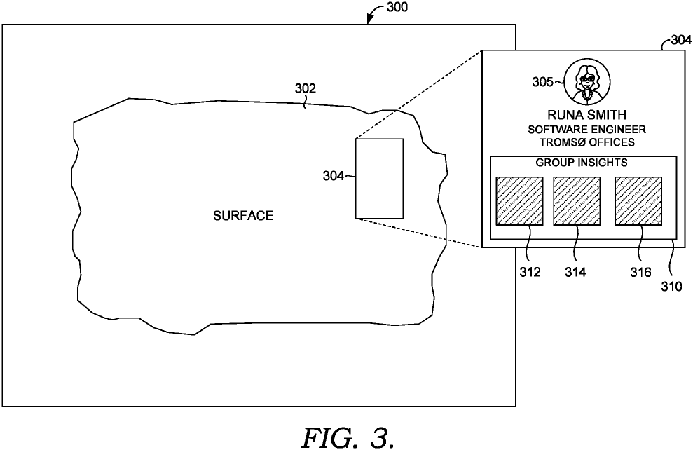

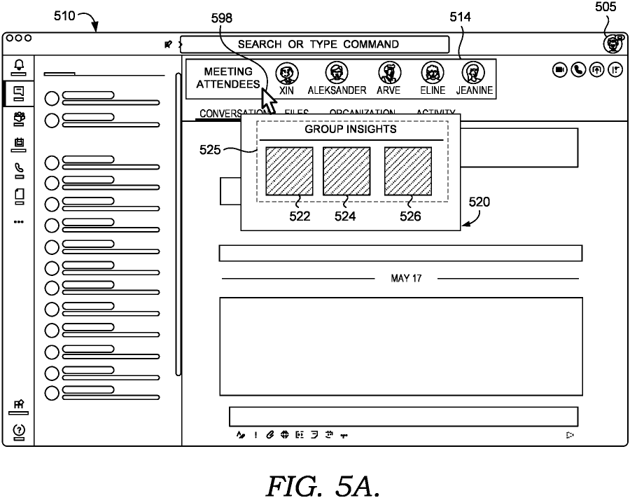

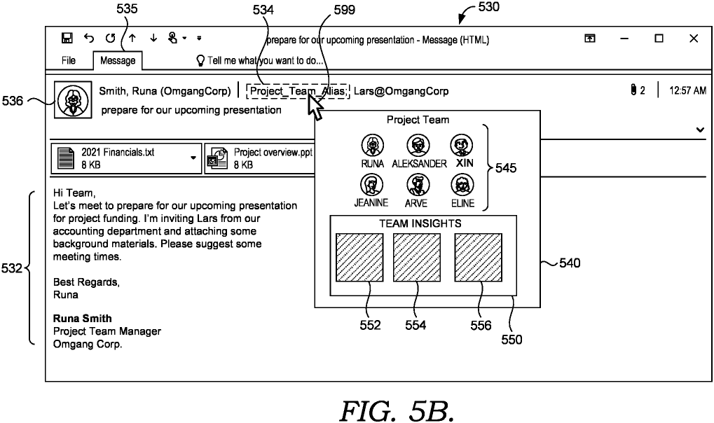

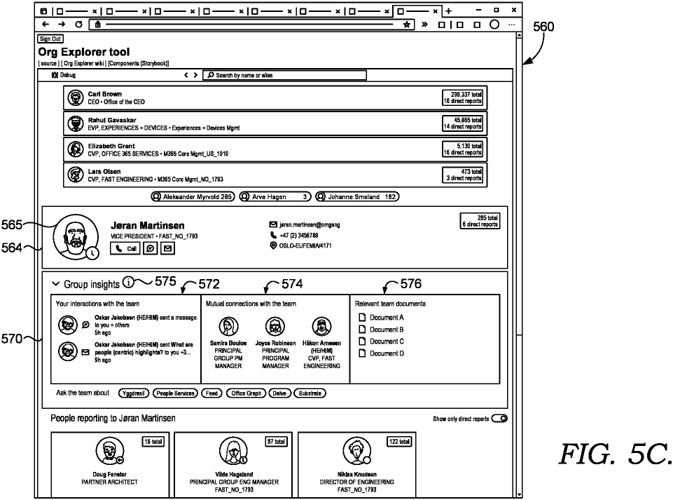

In some embodiments, specific group data may be provided to a user in response to the user interacting with the group (or group member) or an indication of the group (or an indication of a group member). For example, a user interaction may comprise the user accessing a meeting invite that indicates a plurality of people invited to the meeting, or the user accessing an email where the email recipients include a group, or, similarly, a user exploring a group or a team within their organization via an organization explorer application. For instance, in response to a user hovering their cursor over an indication of a group that is an email alias for the group presented in an email application, the user’s computing device may present a GUI window with information items about that group, such as that described further in connection with FIG. 5B. Similarly, a user may interact with an indication of a group member, such as viewing the group member’s profile page in an organization or hovering the user’s cursor over an indication of the group member in an email message or meeting invite. In response to the interaction, the user may be presented with group information about a group to which the group member belongs. For instance, wherein the interaction comprises viewing an organization’s profile page for the group member, the group information may be presented in conjunction with other organizational information about the group member, such as described in connection with FIG. 5C. Additionally or alternatively, where the user hovers their cursor over (or hovers their mouse, or touches, or similarly interacts with) an indication of the group member, a live persona card for the first group member may be presented that includes group information for a group that the first user is a member of, such as described further in connection with FIGS. 3 and 4.

Data associated with a particular user may indicate the user’s intent or purpose for interacting with a particular group of people. As such, the data associated with a particular user may be determined and subsequently used to determine group data for providing to the user. In particular, the group data that is determined for the user may be generated, contextualized, personalized, assembled, filtered, or otherwise determined based on data associated with the user so that the group data provided to the user is relevant to the user. In this way, the aspects of the group data that are presented to the user can be contextually relevant to the user based on the user’s intent, as indicated by this user data. By way of example, and without limitation, such user data associated with a particular user may comprise: information regarding a particular communications application or platform being used by the user; information regarding relationships or shared connections between the user and the group or group members; historic interactions and/or patterns of communication between the user and the group or group members; information derived from the user’s computing device, user activity performed via a computing device, or other information about the user which may be determined via a computing device, such as described herein.

Further, in some embodiments, a set of particular information items in the group data, the amount of group information provided, and/or the presentation or formatting of the group information that is provided to the user may vary or be determined based on the user data associated with the user, such as the user’s context and/or intent. For instance, suppose a first user has regularly interacted with a group and is accessing an indication of the group via a meeting invite for an upcoming meeting, which has been provided via an electronic calendar application, in order to prepare for the meeting. In this scenario, the specific group information items presented to the first user may include information items to facilitate the user’s preparation for the meeting. By way of example and without limitation, this may include recent emails exchanged between the first user and the group regarding the meeting topic, relevant documents attached to those emails, or shared connections of other people who may be attending the upcoming meeting. Now suppose a second user is a new employee who has not previously interacted with the group and is accessing the group via an organizational explorer application, such as Org Explorer by Microsoft®. Perhaps the new employee-user desires to learn about other specific teams in her company. In this context and according to an embodiment, the user is presented with group information items that include information to facilitate understanding of this team’s purpose, such as a charter document or documents by the team that are frequently accessed by non-team members. Moreover, because the new employee-user is accessing the group via an organizational explorer application, in some embodiments the user may be presented with more information (or more detailed information) than what may be presented to the first user who accessed the group via a meeting invite of the electronic calendar application.

The solutions provided by the present disclosure further enable improved control over the processing and presentation or display of contextualized group data on computing devices. In some embodiments, the operation of a computer application, such as a communications application, may be configured or modified to execute computer instructions for presenting a GUI element comprising a set of group information items (or a portion thereof) in response to a user interacting with the group, or an indication of the group, via the computing application. The group data may be assembled into a data structure associated with the group or group members, and also may be used for the provisioning of new communication application functionality and/or for displaying aspects of the group data on a user device based upon a context of the viewing user. In particular, the group data may be used for, among other beneficial computing applications, providing enhanced functionality for communication and collaborative computing applications, improved meeting-scheduling computer services and electronic-messaging applications, determining groups based upon a context, generating and presenting group data, and displaying aspects of the group data on a user device based upon a context. Thus, by determining and processing group data differently than conventional technology, embodiments of this disclosure enable the provision of new functionality for electronic communications computing applications, as well as improved efficiency for electronic communication, enriched electronic communications, and improved computing experiences for users, such as personalized computing experiences, among other improvements described herein.

According to an embodiment, and as further described herein, a particular group is determined. The term “group” is used broadly herein to comprise a plurality of people, such as two or more people, that share a characteristic, such as a property, trait, or objective, in common, which may be used to define membership in the group. The particular group that is determined may be lasting or may be temporary, such as existing for a limited duration of time, depending on the characteristic(s) defining group membership.

A group can be determined based on an indication of at least one group member, such as the name or identifier of the group member or their email address. In some instances, a computer system programmatically determines a group based on an explicit indication of group membership or explicitly defined membership of the group, which may be determined via a company organizational chart, for example. Alternatively or in addition, a group may be inferred by the computer system, for instance, based on an indication of the characteristic(s) of membership defining the group that is detected in group members. For example, user data about potential group members may be used to determine their membership in a group. In one example implementation, a group may be determined programmatically as follows: if a group member has direct reports, such as a set of people that report to them in an organization, then the group comprises the group member and all of the people who directly report to the group member. If the group member does not have direct reports but reports to another person such as a manager, then the group comprises that potential group member, the person they report to, and all of the other people who also report to that other person.

As many companies and organizations lack managerial or organizational infrastructure to define or determine explicit groups within their organization, it is advantageous to provide computing functionality for inferring groups, based on the user data of potential group members. Moreover, it is contemplated that users, including group members, may be required to opt in or consent to having their data used for determining group membership. In some embodiments, a set of potential group members to be programmatically considered for determining a group comprises the employees of an organization, or, a set of potential group members may be determined by a domain, such as a common email domain, or an address (or location information for activity occurring) within a specific area.

Next, subsequent to determining a particular group, group data is determined regarding the group, and at least a portion of the determined group data is provided to the user. In some embodiments, the group data comprises a set of one or more group information items that characterize aspects of the particular group, which may be determined or provided as categories of group information, as described previously. The group data may be determined based on data associated with the group or one or more members of the group, data associated with the particular user, or a combination thereof. As data associated with a user can indicate the user’s context, in some instances where the group data is determined based on data associated with the user (or based in part on data associated with the user), the group data may be considered to be determined based on the user context. For instance, if the user data indicates that the user is accessing an indication of the group via a meeting invite, which the user may be doing to prepare for an upcoming meeting, then the group data may comprise a set of information items indicating documents associated with the group that are relevant to the upcoming meeting.

Data associated with the group or group members may comprise explicit or inferred information about the group or group members, such as that further described herein. An example of explicit information about a group might comprise a charter document regarding the purpose of the group or group objectives that are explicitly declared. An example of inferred data associated with a group might comprise user activity related to the group performed by other people, such as file accesses, performed by other people, of files related to the group, or, similarly, the frequency, rate, or count of file accesses of files related to the group performed by other people. For example, it may be inferred that a particular document related to the group should be included in the group data for presentation to the user based on the documents being frequently accessed by other people.

Subsequent to determining group data regarding a particular group, the group data (or a portion of group data) may be assembled and formatted, or otherwise prepared for presentation to the user. According to some embodiments, user data associated with a particular user, which may indicate that user’s context and/or intent for interacting with the group (or group member), may be used to determine: a set of particular information items in the group data to be provided to the user, the amount of group data provided, and/or the presentation or formatting of the group data that is to be provided to the user. For example, in some implementations, the group data (or a portion thereof) may be formatted for presentation to the user via a particular computing application being used by the user, which may be determined from the user data associated with the user. In some embodiments, user data associated with a particular user is used for ranking or prioritizing specific group data for presentation to the particular user, which, for instance, can be based on an inferred relevance to the user. For example, some embodiments determine a relevance weight for each group information item of the group data and use the relevance weight to determine which group information items to provide to the user. Moreover, as the group data that is determined and/or presented to the user can be based on user data associated with the user in some embodiments, it follows then that two different users being provided group data about the same group may receive different group data. For instance, each of the two users may be provided with group data that is relevant (for example, contextualized or personalized) for that user. Alternatively, in some embodiments, particular group data and/or its presentation or formatting is not based on user data associated with that user.

### Overview of Technical Problems, Technical Solutions, and Technological Improvements

The coalescence of telecommunications and personal computing technologies in the modern era has enabled, for the first time in human history, information on demand and an ubiquity of personal computing resources (including mobile personal computing devices and cloud-computing coupled with communication networks). As a result, it is increasingly common for users to rely on one or more mobile computing devices throughout the day for handling various tasks. It is also now possible to provide information to the user regarding groups of people that may be relevant to a particular task, location, communication, application use, or other contextual situation, referred to collectively as group data.

As described previously, people spend significant time communicating with and in meetings with other people, including time collaborating or working in teams, and it can be helpful for a user to have contextual information presented about the other users or the group. For example, when a user has a meeting with or communicates with a team, it would be helpful to provide the user with information about the team that is relevant to the user. Similarly, it can be helpful for new employees or users who are unfamiliar with a particular group to be provided with contextual information about that group so that those users’ interactions with the group are more effective or efficient.

However, the conventional technology lacks computing functionality to programmatically determine and provide contextual data that characterizes aspects of a group of people with respect to a user, nor does the conventional technology include functionality for using the contextualized group data to provide improved computing applications and an improved user computing experience. In particular, existing approaches for providing such information about groups of people requires manual curation and preparation of information by a human. For example, an administrator or group secretary must first manually specify the group of people and then look up and aggregate data about each individual in the group. Unfortunately, because the group data must be manually determined by a human, it will be the same for all users, and additionally, the same information will be presented every time (for example, it is static and does not change). Therefore, the group data is not contextualized or personalized to a particular user interacting with the group. Further compounding this problem, many companies and organizations do not have the infrastructure or organization in place to know the teams or groups that exist within their company or organization. Thus, in these situations, even if a human administrator were to be tasked with the manual curation and preparation of the group data, the administrator may be unable to determine particular groups within their organization.

Accordingly, automated computing technology for programmatically determining, surfacing, and/or utilizing contextualized group data, as provided herein, can be beneficial for enabling improved computing applications and an improved user computing experience. Further, embodiments of this disclosure address a need that arises from a very large scale of operations created by software-based services that cannot be managed by humans. The actions/operations described herein are not a mere use of a computer, but address results of a system that is a direct consequence of software used as a service offered in conjunction with user communication through services hosted across a variety of platforms and devices. Further still, embodiments of this disclosure enable an improved user experience across a number of computer devices, applications, and platforms. Further still, embodiments described herein enable certain group data to be programmatically surfaced and presented without requiring computer tools and resources for a user to manually perform operations to produce this outcome. In this way, some embodiments, as described herein, reduce or eliminate a need for certain databases, data storage, and computer controls for enabling manually performed steps by an administrator, to search, identify, assess, and configure (e.g., by hard-coding) specific, static group data to be presented to users, thereby reducing the consumption of computing resources.

### ADDITIONAL DESCRIPTION OF THE EMBODIMENTS

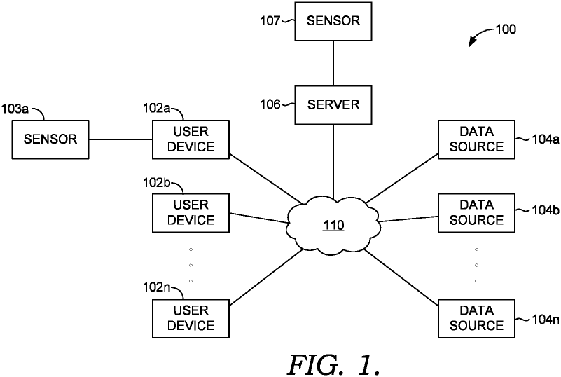

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

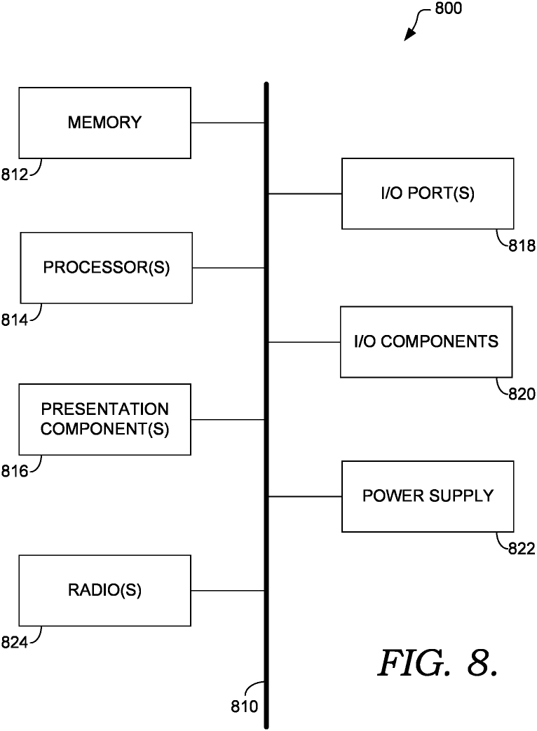

Among other components not shown, example operating environment 100 includes a number of user computing devices, such as: user devices 102a and 102b through 102n; a number of data sources, such as data sources 104a and 104b through 104n; server 106; sensors 103a and 107; and network 110. It should be understood that environment 100 shown in FIG. 1 is an example of one suitable operating environment. Each of the components shown in FIG. 1 may be implemented via any type of computing device, such as computing device 800 described in connection to FIG. 8, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client user devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one embodiment, user devices 102a through 102n may be the type of computing device described in relation to FIG. 8 herein. By way of example and not limitation, a user device may be embodied as a personal computer (PC), a laptop computer, a mobile or mobile device, a smartphone, a smart speaker, a tablet computer, a smart watch, a wearable computer, a personal digital assistant (PDA) device, a music player or an MP3 player, a global positioning system (GPS) or device, a video player, a handheld communications device, a gaming device or system, an entertainment system, a vehicle computer system, an embedded system controller, a camera, a remote control, an appliance, a consumer electronic device, a workstation, any other suitable computer device, or any combination of these delineated devices.

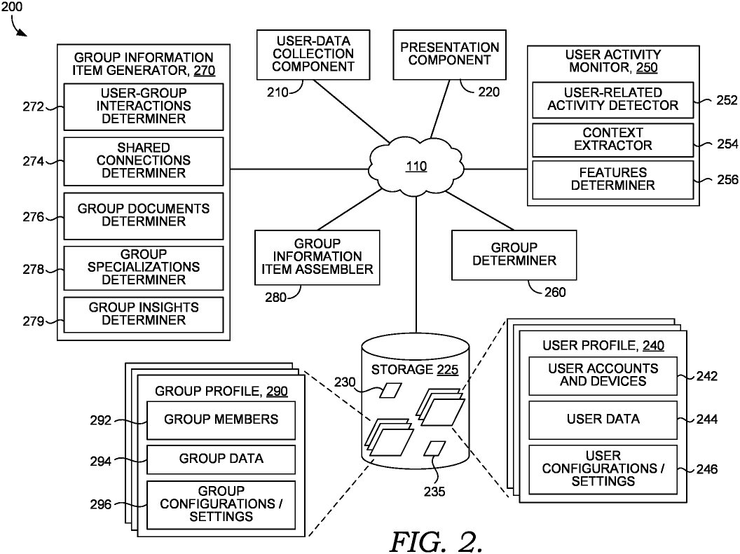

Data sources 104a and 104b through 104n may comprise data sources and/or data systems, which are configured to make data available to any of the various constituents of operating environment 100 or system 200 described in connection to FIG. 2. For instance, in one embodiment, one or more data sources 104a through 104n provide (or make available for accessing), to user-data collection component 210 of FIG. 2, user data, which may include user-activity related data, and which may comprise group data or group member data. Data sources 104a and 104b through 104n may be discrete from user devices 102a and 102b through 102n and server 106 or may be incorporated and/or integrated into at least one of those components. In one embodiment, one or more of data sources 104a through 104n comprise one or more sensors, which may be integrated into or associated with one or more of the user device(s) 102a, 102b, or 102n or server 106. Examples of sensed people data made available by data sources 104a through 104n are described further in connection to user-data collection component 210 of FIG. 2.

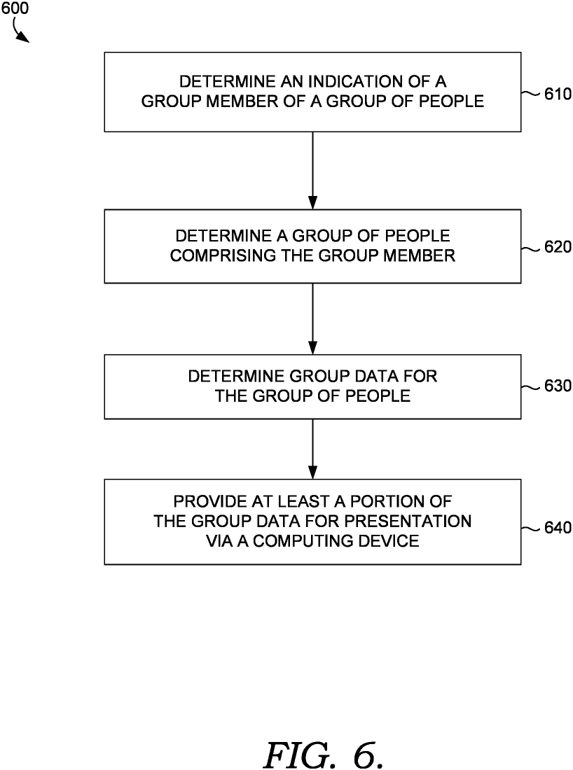

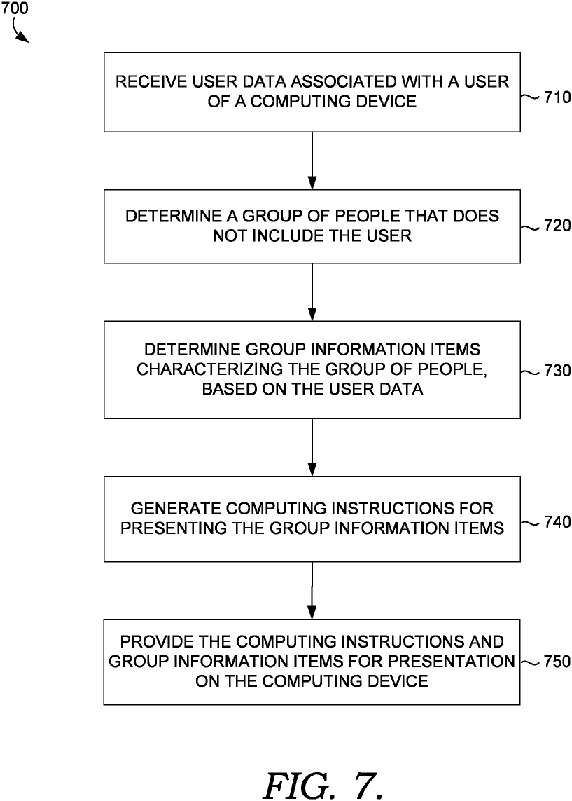

Operating environment 100 can be utilized to implement one or more of the components of system 200, described in FIG. 2, including components for collecting user data, which may comprise: group member data, group data, or user data; monitoring user activity to determine user data or user data features; user preferences, and/or similar categories of data regarding a group or a particular person of interest, such as a group member, context data, or related information to facilitate sharing context or to otherwise provide an improved user experience; group data generation and processing; and/or consuming or presenting group data to users. Operating environment 100 can also be utilized for implementing aspects of methods 600 and 700 in FIGS. 6 and 7, respectively.

Referring now to FIG. 2, with continuing reference to FIG. 1, a block diagram is provided showing aspects of an example computing system architecture suitable for implementing an embodiment of this disclosure and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200, including user-data collection component 210, presentation component 220, user activity monitor 250, group determiner 260, group information item generator 270, group information item assembler 280, and storage 225. User activity monitor 250 (including its subcomponents 252, 254, and 256), group determiner 260, group information item generator 270 (including its subcomponents 272, 274, 276, 278, and 279), group information items assembler 280, user-data collection component 210, and presentation component 220, may be embodied as a set of compiled computer instructions or functions, program modules, computer software services, or an arrangement of processes carried out on one or more computer systems, such as computing device 800, described in connection to FIG. 8, for example.

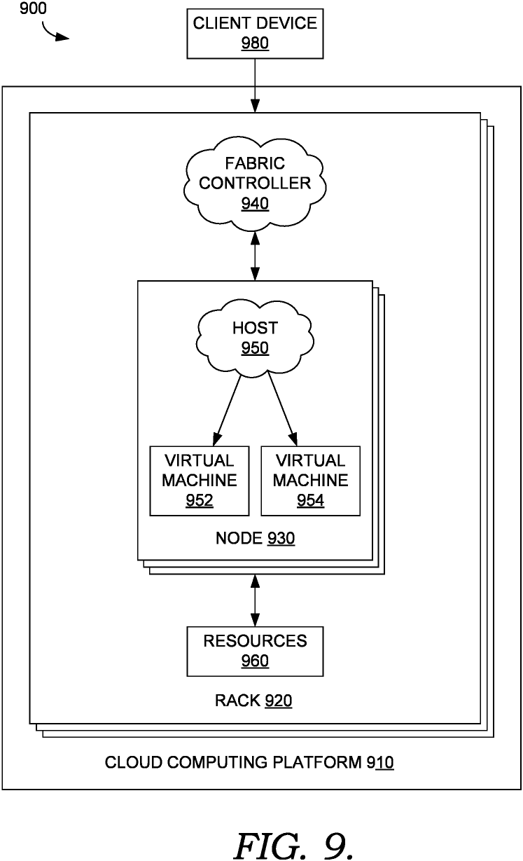

In one embodiment, the functions performed by components of system 200 are associated with one or more computer applications, services, or routines, such as an online meeting application, a communications or collaboration application, a Live Persona Card (“LPC”) or user profile service, or an organizational explorer application. The functions may operate to determine or provide contextualized group data to a user, group data in association with a group member, or otherwise to provide an enhanced computing experience for a user. In particular, such applications, services, or routines may operate on one or more user devices (such as user device 102a) or servers (such as server 106). Moreover, in some embodiments, these components of system 200 may be distributed across a network, including one or more servers (such as server 106) and/or client devices (such as user device 102a) in the cloud, such as described in connection with FIG. 9, or may reside on a user device, such as user device 102a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. Additionally, although functionality is described herein with regard to specific components shown in example system 200, it is contemplated that in some embodiments, functionality of these components can be shared or distributed across other components.

Continuing with FIG. 2, user-data collection component 210 is generally configured to access or receive (and in some cases also identify) user data, which may include data associated with a particular user, data associated with a group member, or group data from one or more data sources, such as data sources 104a and 104b through 104n of FIG. 1. In some embodiments, user-data collection component 210 may be employed to facilitate the accumulation of user data of a particular user, group member, or group (or in some cases, a plurality of users including crowdsourced data) for user activity monitor 250 or its subcomponents, group determiner 260, group information item generator 270 or its subcomponents, or group information item assembler 280. The data may be received (or accessed), and optionally accumulated, reformatted, and/or combined, by user-data collection component 210 and stored in one or more data stores such as storage 225, where it may be available to other components of system 200. For example, the user data may be stored in or associated with a user profile 240, as described herein, such as in user data 244 of user profile 240, or may be stored in or associated with a group profile 290, as described herein, such as in group data 294 of group profile 290. In some embodiments, any personally identifying data (i.e., user data that specifically identifies particular users) is either not uploaded or otherwise provided from the one or more data sources with group data, is not permanently stored, is de-identified, and/or is not made available to other components of system 200. In addition or alternatively, in some embodiments, a user may opt into or out of services provided by the technologies described herein and/or select which user data and/or which sources of user data are to be captured and utilized by these technologies.

User data, generally, may comprise any information that is related to a person, or group of people, that informs a user about an aspect of that person or group of people, and may be received from a variety of sources and may be available in a variety of formats. By way of example and without limitation, user data may comprise: contact information (e.g., email, instant message, phone, and may also specify a person’s communication preferences); location information (e.g., a person’s current location or location of a particular office where they work); presence; user-related activity, which may comprise activity relevant to a user or group member, such as communications information (e.g., past email, meetings, chat sessions, communication patterns or frequency, information about a user or users that a group member had a meeting with or has an upcoming meeting with, or information about communications between a group member and one or more users ), files access (e.g., a file created, modified, or shared), social media or online activity, such as a post to a social-media platform or website, subscription information, information regarding topics of interest to a user, or other user-related activity that may be determined via a user device; task-related information (e.g., an outstanding task that the user has with regard to a group member or group or outstanding tasks that a group member or group has with respect to the user); information about a group or group member that they may choose to share (e.g., birthday, anniversary, etc.); or information in common with the user (e.g., common project teams, work groups, backgrounds, education, interests, or hobbies). Additional examples of user data are described herein.

In some embodiments, user data received via user-data collection component 210 may be obtained from a data source (such as data source 104(a) in FIG. 1, which may be a social networking site, a professional networking site, a corporate network, an organization intranet or file share, or other data source containing user or group data) or determined via one or more sensors (such as sensors 103a and 107 of FIG. 1), which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both. By way of example and not limitation, user data may include data that is sensed, detected, or determined from one or more sensors (referred to herein as sensor data), such as location information of mobile device(s), properties or characteristics of the user device(s), user-activity information (for example: app usage; online activity; searches; voice data such as automatic speech recognition; activity logs; communications data, including calls, texts, chats, messages, and emails; document comments; website posts; other user data associated with communication events, including user history, session logs, application data, contacts data, calendar and schedule data, notification data, social-network data, ecommerce activity, user-account(s) data (which may include data from user preferences or settings associated with a personalization-related application, a personal assistant application or service, an online service or cloud-based account such as Microsoft 365, an entertainment or streaming media account, a purchasing club or services); global positioning system (GPS) data; other user device data (which may include device settings, profiles, network-related information, payment or credit card usage data, or purchase history data); other sensor data that may be sensed or otherwise detected by a sensor (or other detector) component(s), including data derived from a sensor component associated with the user (including location, motion, orientation, position, user-access, user-activity, network-access, user-device charging, or other data that is capable of being provided by one or more sensor component); data derived based on other data (for example, location data that can be derived from Wi-Fi, cellular network, or IP address data), and nearly any other source of data that may be sensed, detected, or determined as described herein.

User data, particularly in the form of context data or contextual information regarding a particular user, can be received by user-data collection component 210 from one or more sensors and/or computing devices associated with the user. In some embodiments, user-data collection component 210, user activity monitor 250 or its subcomponents, group determiner 260, group information item generator 270 or its subcomponents, or other components of system 200 may determine interpretive data from received user data. Interpretive data corresponds to data utilized by the components or subcomponents of system 200 that comprises an interpretation from processing raw data, such as venue information interpreted from raw location information, or topic information interpreted from an email. Interpretive data can be used to provide context to user data, which can support determinations or inferences carried out by components of system 200. Moreover, it is contemplated that some embodiments of the disclosure utilize user data alone or in combination with interpretive data for carrying out the objectives of the subcomponents described herein. It is also contemplated that some user data may be processed by the sensors or other subcomponents of user-data collection component 210 not shown, such as for interpretability by user-data collection component 210. However, embodiments described herein do not limit the user data to processed data and may include raw data or a combination thereof, as described above.

In some respects, user data may be provided in user-data streams or signals. A “user signal” can be a feed or stream of user data from a corresponding data source. For example, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, user-data collection component 210 receives or accesses data continuously, periodically, as it becomes available, or as needed. In some embodiments, the user data, which may include group data and group member data, and which may be received by user-data collection component 210 is stored in storage 225, such as in user data 244 or group data 294.

User activity monitor 250 is generally responsible for monitoring user activity for information that may be used for determining user data for one or more users, which can include group data, group member data, or user data associated with a particular user. In some embodiments, user data associated with a particular user determined via user activity monitor 250 comprises contextual information. In some embodiments, this user data may be utilized by other components of system 200 to infer an intent of the particular user and/or to further determine group data or group member data, which may be provided to the particular user. In particular, embodiments of user activity monitor 250 may determine user data associated with a particular user, which may include user-related activity data and/or context data, and may provide the determined user data as structured data, such as a set of data features, so that it may be used by other components of system 200. For instance, as further described herein, the user data may be used by group information item determiner 270 to determine a set of group information items about a group of people for presentation to the user, such that the group information items are relevant to the user’s context, which may be indicated by the user data. Accordingly, in some embodiments, user data determined by user activity monitor 250 or its subcomponents may be used to determine contextualized group data for the user. The user data determined by user activity monitor 250 or its subcomponents may also be stored in a user profile associated with a user, such as in user data 244 of user profile 240, where it may be accessible to other components of system 200. Similarly, in some implementations, group data or group member data determined by user activity monitor 250, or its subcomponents, may be stored in a group profile associated with a particular group, such as in user data 244 of user profile 240, where it may be accessible to other components of system 200.

In some embodiments, user activity monitor 250 may determine current or near-real-time user activity information and may also determine historical user activity information, which may be determined based on gathering observations of user activity over time, accessing user logs of past activity (such as communication history, for example). Accordingly, user activity monitor 250 can determine current and historic user activity information that may be used by user activity monitor 250 or other components of system 200 to determine, for example, that: a particular user currently works with (or previously worked with) another user, such as a group member; has communicated with or received shared communications with the other user; or that the particular user and the other user have attended meetings together, have similar interests or similar characteristics, have worked in the same office or location, have accessed or worked on the same file or related files, such as files that may be part of a project, or that the particular user and the other user share a connection with a third user.

The user data determined by user activity monitor 250 (or its subcomponents) may include user-related activity information from one or multiple user devices associated with a user and/or from cloud-based services associated with a user (such as email, calendars, social media, or similar information sources), and may further include contextual information associated with the user activity or user data. For example, information about user activity on a particular device or cloud-based service may be used to determine a context associated with the user, which may be used for determining a group of people or aspects of group data for displaying to the user or providing to a computing application or service. In an embodiment, user activity monitor 250 comprises one or more computing applications or services that analyze information detected via one or more user devices used by a user and/or cloud-based services associated with the user to determine activity information and/or contextual information. Information about user devices associated with a user may be determined from the user data made available via user-data collection component 210, and may be provided to user activity monitor 250 or other components of system 200. More specifically, in some implementations of user activity monitor 250, a user device may be identified by detecting and analyzing characteristics of the user device, such as device hardware, software (such as operating system [OS]), network-related characteristics, user accounts accessed via the device, and similar characteristics. For example, information about a user device may be determined by using functionality of many operating systems to provide information about the hardware, OS version, network connection information, installed application, or the like.

Some embodiments of user activity monitor 250 or its subcomponents may determine a device name or identification (device ID) for each device associated with a user. This information about the identified user devices associated with a user may be stored in a user profile associated with the user, such as in user accounts and devices 242 of user profile 240. In an embodiment, a user device may be polled, interrogated, or otherwise analyzed to determine information about the device. This information may be used for determining a label or identification of the device (e.g., a device ID) so that user interaction with the device may be recognized from user data by user activity monitor 250. In some embodiments, users may declare or register a device, such as by logging into an account via the device, installing an application on the device, connecting to an online service that interrogates the device, or otherwise providing information about the device to an application or service. In some embodiments, devices that sign into an account associated with the user, such as a Microsoft® account (MSA), email account, social network, or the like, are identified and determined to be associated with the user.

As shown in example system 200, user activity monitor 250 comprises a user-related activity detector 252, context extractor 254, and features determiner 256. In some embodiments, user activity monitor 250, one or more of its subcomponents, or other components of system 200 may determine interpretive data based on received user data, such as described previously. It is contemplated that embodiments of user activity monitor 250, its subcomponents, and other components of system 200 may use the user data and/or interpretive data for carrying out the objectives of the subcomponents described herein. Additionally, although several examples of how user activity monitor 250 and its subcomponents may identify user-related activity information are described herein, many variations of user activity identification and user activity monitoring are possible in various embodiments of the disclosure.

User-related activity detector 252, in general, is responsible for determining (or identifying) that a user action or user-activity event has occurred. Embodiments of user-related activity detector 252 may be used for determining current user activity or historical user actions. Some embodiments of user-related activity detector 252 may monitor user data for activity-related features or variables corresponding to various user activity such as indications of communications with other users, locations or visits, information about meetings attended, applications launched or accessed, files accessed or shared, websites navigated to, media played, or similar user activities. Additionally, some embodiments of user-related activity detector 252 may extract, from the user data, information about user-related activity, which may include current user activity, historical user activity, and/or related information such as context. Alternatively, or in addition, in some embodiments context extractor 254 determines and extracts context. Similarly, in some embodiments features determiner 256 extracts information about a user, such as user-related activity features, based on an identification of the activity determined by user-related activity detector 252. Examples of extracted user-related activity information may include user location, app usage, online activity, searches, communications such as call or message information, usage duration, application data (e.g., emails, meeting invites, messages, posts, user status, notifications, etc.), or nearly any other data related to user interactions with the user device or user activity via a user device. For example, a user’s location may be determined using GPS, indoor positioning (IPS), or similar communication functionalities of a user device associated with a user.

Data determined from user-related activity detector 252 may be provided to other subcomponents of user activity monitor 250 or other components of system 200, or may be stored in a user profile associated with the user, such as in user data 244 of user profile 240. In some embodiments, user-related activity detector 252 or user activity monitor 250 (or its other subcomponents) performs conflation on detected user data. For example, overlapping information may be merged and duplicated, or redundant information may be eliminated.

In some embodiments, the user activity-related features may be interpreted to determine that particular user activity has occurred. For example, in some embodiments, user-related activity detector 252 employs user-activity event logic, which may include rules, conditions, associations, classification models, or other criteria to identify user activity. For example, in one embodiment, user activity event logic may include comparing user activity criteria with the user data in order to determine that an activity event has occurred. Similarly, activity event logic may specify types of detected user-device interaction(s) that are associated with an activity event, such as navigating to a website, composing an email, or launching an app. In some embodiments, a series or sequence of user device interactions may be mapped to an activity event, such that the activity event may be detected upon determining that the user data indicates that the series or sequence of user interactions has been carried out by the user.

In some embodiments, user activity detector 252 runs on or in association with each user device for a user. User activity detector 252 may include functionality that polls or analyzes aspects of the operating system to determine user activity related features (for example, installed or running applications or file accesses and modifications), network communications, and/or other user actions detectable via the user device including sequences of actions.

Context extractor 254 is generally responsible for determining a context associated with user-related activity or user data. As further described herein, a context (or context logic) may be used to determine a group or group data, to assemble or format group data for presentation to a user, or for consumption by a computing application. By way of example, a context may comprise information about a user’s current activity, such as application usage, communication or interaction with other user(s), such as a group member, or interaction with user data for other users. For instance, a context can indicate types of user activity, such as a user attending or scheduling a meeting with at least another user, sending a message to one or more other users, or viewing a Live Persona Card (“LPC”) or other user profile of another user. Alternatively, or in addition, a user may explicitly provide a context, such as performing a query about another user, which may be performed via an organizational explorer application. A context may include information about another user, such as a second user (or plurality of users or a group or users) that the user is interacting with or accessing information about, as in where a user hovers their mouse over an indication of another user to view a portion of an LPC.

Some embodiments of context extractor 252 determine context related to a user action or activity event, such as people entities identified in a user activity or related to the activity (e.g., recipients of a group email sent by the user, which may be sent to an alias corresponding to a group), which may include nicknames used by the user (e.g., “mom” and “dad,” referring to specific entities who may be identified in the user’s contacts by their actual names, or group names such as “project team” or “book club,” which may refer to specific groups of people identifiable from user data), and may utilize a named-entity extraction model or named-entity recognition model. Context extractor 252 may also determine location- or venue-related information about a user’s device, which may include information about other users or people present at the location. By way of example and not limitation, this may include context features such as: location data; contextual information about the location; duration of a user activity; other information about the activity such as entities associated with the activity (e.g., venues, people, and objects); information detected by sensor(s) on user devices associated with the user that is concurrent or substantially concurrent to the detected user activity; or any other data related to the user activity that is detectable and that may be used for determining a context of the user-related activity.

In some embodiments, context extractor 254 comprises one or more applications or services that parse or analyze information detected via one or more user devices used by the user and/or cloud-based services associated with the user to identify, extract, or otherwise determine a user-related or user-device-related context. Alternatively, or in addition, some embodiments of context extractor 254 may monitor user data, such as that received by user-data collection component 210 or determined by user-related activity determiner 252, for information that may be used for determining a user context. In some embodiments, this information may comprise features (sometimes referred to herein as “variables”) or other information regarding specific user-related activity and related contextual information. Some embodiments of context determiner 252 may determine, from the monitored user data, a user context associated with a particular user or user device or a plurality of users (such as a specific group of people) and/or user devices. In some embodiments, a user context determined by context extractor 254 may be provided to other components of system 200 or stored in a user profile associated with a user, such as in user data 244 of user profile 240, where it may be accessed by other components of system 200.

Features determiner 256 is generally responsible for determining or extracting a set of one or more data features (or variables) characterizing the user and/or for determining structured user data associated with a user. User features may be determined from information about user data received from user-data collection component 210 or from user-related activity data, which may include context data determined by user activity monitor 250. In some embodiments, features determiner 256 receives information from one or more of these other components of system 200 and processes the received information to determine a set of one or more features associated with a user. For example, user data processed by features determiner 256 may comprise unstructured, semi-structured, or structured data about a user (or other users). In some embodiments, this received user data may be converted into a structured data schema or record, a feature vector, a set of data feature-value pairs, or other data record that is usable for determining a group of people or group data. The user features or structured user data determined by features determiner 256 may be provided to other components of system 200 or stored in a user profile associated with a user, such as in user data 244 of user profile 240, where it may be accessed by other components of system 200.

Examples of user features determined or extracted by features determiner 256 may include, without limitation: data from information sources associated with the user, such as an organizational chart or employment data (e.g., who a user reports to, works with, manages [or who reports to a user]; a user’s role; information about project team(s), which can include project-team members, or similar information); social media or social collaboration information sources (e.g., the user’s LinkedIn® connections or GitHub® contributions or collaborations); location-related features; venue-related information associated with the location or other location-related information; other users present at a venue or location; time-related features; current-user-related features, which may include information about the current or recent user of the user-device; user device-related features, such as device type (e.g., desktop, tablet, mobile phone, fitness tracker, heart rate monitor, or other types of devices), hardware properties or profiles, OS or firmware properties, device IDs or model numbers, network-related information, position/motion/orientation-related information about the user device, network usage information, app usage on the device, user account(s) accessed or otherwise used (such as device account(s), OS level account(s), or online/cloud-service related account(s) activity, such as Microsoft® MSA account, online storage account(s), email, calendar, meetings, or social networking accounts); content-related features, such as meeting topics, presentations, or attendees; online activity (e.g., searches, browsed websites, purchases, social networking activity, communications sent or received including social media posts); or any other features that may be detected or sensed and used for determining data associated with or characterizing a user.

Some embodiments of features determiner 256, or more generally user activity monitor 250, can determine interpretive or semantic data from the user data, which may be used to determine user data features or other structured user data. For example, while a user-activity feature may indicate a location visited by the user, a semantic analysis may determine information about the location, such as that the location is a gym, a coffee house, or a company office, or to determine other data associated with detected user activity or user data. Thus, semantic analysis may determine additional user-activity related features or user data that is semantically related to other data and which may be used for further characterizing the user or for determining a context.

In particular, a semantic analysis may be performed on at least a portion of user data to characterize aspects of the user data. For example, in some embodiments, user-related activity features may be classified or categorized (such as by type, time frame or location, work-related, home-related, themes, related entities, other user(s) [such as communication to or from another user] and/or relation of the other user to the user [e.g., family member, close friend, work acquaintance, boss, or the like], or other categories), or related features may be identified for use in determining a similarity or relational proximity to other user-related activity events. In some embodiments, a semantic analysis may utilize a semantic knowledge representation, such as a relational knowledge graph. A semantic analysis may also utilize semantic analysis logic, including rules, conditions, or associations to determine semantic information related to a user activity. For example, a user-related activity event comprising an email sent to someone who works with the user may be characterized as a work-related activity, which may be used to infer a relationship that the user works with the email recipient. A semantic analysis may also be used to further determine or characterize a context, such as determining that a location associated with user-related activity corresponds to a hub or venue of the user (such as the user’s home, work, gym, or the like) based on frequency of user visits. For example, the user’s home hub may be determined (using semantic analysis logic) to be the location where the user spends most of her time between 8 PM and 6 AM. Similarly, the semantic analysis may determine the time of day that corresponds to working hours, lunch time, commute time, or other similar categories.

Continuing with FIG. 2, group determiner 260 is generally responsible for determining a particular group of people. A group may comprise two or more people that share a characteristic, such as a property, trait or objective, in common, that can be used to define membership in the group. The group determined by group determiner 260 may be a lasting or temporary group, such as a group existing for a limited duration of time, depending on the characteristic(s) defining group membership. As non-limiting examples, a particular group determined by group determiner 260 may comprise: a project team within a company with an objective of completing a project; a product-development team or service team intended to exist for the development or support of a product or service; a set of employees that work at a particular office location (for example, the Oslo office or the seventh floor); a set of employees of the same division of a company (for example, employees of the marketing department) or having similar employment role, such as sales or IT support; a standing or an ad hoc committee; a set of people that live or reside in an area, such as a particular neighborhood; an organization; an association; a club; a panel; a board; a club; a party; or other group of two or more people that share at least one characteristic, which defines membership of the group. In some embodiments, the group may comprise: attendees of an event (or invited attendees of an event), such as a meeting; recipients of a communication such as an email; participants of a group chat session; or subscribers of information or a service, such as subscribers of a social media interest channel or topic channel in a company news feed.

In some embodiments, group determiner 260 can determine a particular group based on an indication of at least one group member of the group. A group member indication may comprise, by way of example and without limitation, the name of the group member; their email address; an identifier of the group member in a communications application such as a chat application, online meeting application, or Teams by Microsoft®; a comment by the group member in a document; an identifier or similar indication of the group member in a meeting invite; an identifier of the group member in an organizational chart or roster of the group; a profile of the group member, such as a social media profile or company profile for the group member; or another indication of the group member that may be utilized to identify the group member from other people. In some embodiments, an indication of a group member is determined by group determiner 260 based on user data, which may be received from user activity monitor 250 (or one of its subcomponents) from user data stored in a user profile, such as user data 244 in user profile 240, or from user-data collection component 210. In some instances, an indication of a group member may be determined based on activity performed by a particular user, such as a user interacting with the indication of the group member. For instance, the user activity data may indicate the user querying a group member in an organization explorer tool, or hovering their cursor on (or over) an email address of the group member, meeting attendee identifier, name, or other indication of the group member such as described herein. Further, in some embodiments, a group determined by group determiner 260 does not include the particular user as a member of the group. For instance, in these embodiments, a group that is determined comprises a plurality of people having a common characteristic, such as described herein, wherein the user does not have the common characteristic, and thus is not a member of the group.

Some embodiments of group determiner 260 utilize group-determination logic 230 for determining a particular group of people. Group-determination logic 230 can comprise computer instructions including rules, conditions, associations, classification models, or other criteria for determining a group of people. In some embodiments, group-determination logic 230 includes logic, such as computer-executable instructions, for detecting an indication of a group member from user data, such as user activity data determined by user activity monitor 250.

Further, some embodiments of group-determination logic 230 include logic to programmatically determine a group based on an explicit indication of group membership or explicitly defined membership of the group. (Alternatively, in embodiments without group-determination logic 230, group determiner 260 may programmatically determine a group in a similar manner.) For example, group-determination logic 230 may specify instructions for identifying or determining an explicit indication of a group (or group membership or an explicit definition of membership) from user data, which may include group data, group member data, or user data associated with particular users. The user data may be received from user activity monitor 250, a user profile 240, or user-data collection component 210. By way of example and without limitation, an explicit indication of a group may be provided from: a company organizational chart; a list, roll, roster, or group email alias, which may be specified by a manager, administrator, or team leader; membership indicated via the group members, such as an indication provided on a company profile page or social media profile, or a group member indicating that they are part of a particular group like a project team; an indication from a communication, such as recipients of an email, or an event, such as a meeting invite; or similar explicit indications of the members forming the group. In some instances, an explicit indication of a particular group may be determined from a group profile 290 for the group, such as in the instance where a group has been previously determined by group determiner 260, and a group profile 290 for the group has been created and stored in storage 225.

Alternatively or in addition, group-determination logic 230 may comprise logic for inferring a group of people, based, for instance, on an indication of a characteristic of membership defining the group that can be detected in group members. Accordingly, a set of potential group members may be evaluated by group determiner 260 to determine their membership in a group. For example, user data for the set of potential group members, which indicates a characteristic of each group member, may be utilized by group determiner 260 to determine membership of the potential group members in a group. The set of potential group members may be determined based on a set of users identified from user data, which may be received from user activity monitor 250, user-data collection component 210, or another component of system 200.

Some embodiments of group-determination logic 230 include logic for querying or processing user data for a potential group member to detect one or more characteristics for defining group membership. For instance, in an embodiment, group-determination logic 230 includes logic for performing comparison of user data to determine similarities among potential group members to determine that they are part of a group and/or specifying explicit or predefined user data to evaluate and determine group membership. For example, group-determination logic 230 may include a set of rules for comparing user-data feature values (which may be determined by features determiner 256), corresponding to a characteristic of a group or group members, for determining identical data feature types, and/or determining a level of similarity for feature values of similar feature types. For instance, some embodiments may utilize classification models such as statistical clustering (e.g., k-means or nearest neighbor) or a proximity of features to each other on a semantic knowledge graph, neural network, or other classification techniques to determine similarity.

In some embodiments, group-determination logic 230 specifies certain kinds of user data for use by group-determiner 260 to infer a group. For example, and without limitation, data used to infer group membership may comprise user activity data or other user data about potential group members, such as: location information, file access information, information regarding communications, which may include patterns or frequency of communication or meetings, social media data, email address, such as a company email domain, access or permissions such as access to a particular computer resource, office location, information indicating a person that the potential group member reports to, information indicating a set of people who report to the potential group member, browsing activity, purchase activity, or other available data, which may be determinable by user computing device. In some embodiments, a set of potential group members to be programmatically considered for determining a group comprises the employees of an organization, or, a set of potential group members may be determined by a domain, such as a common email domain or an address (or location information for activity occurring) within a specific area.

In an example embodiment, group-determination logic 230 includes logic for programmatically determining a group as follows: based on an indication of a group member, which may be determined as described previously, if the group member has direct reports, such as a set of people that report to them in an organization, then the group comprises the group member and all of the people able to be determined who directly report to the group member. If the group member does not have direct reports but reports to another person such as a manager, then the group comprises that group member, the person they report to, and all of the other people able to be determined who also report to that other person. Whether a group member has direct reports or reports to another person may be determined based on an explicit indication provided by an organizational chart or inferred, for example, based on patterns of communication associated with the group member.

In some embodiments, group-determiner 260 may determine (or group-determination logic 230 may include logic for determining) a set of candidate groups. For example, a set of candidate groups may be determined based on an indication of at least one group member who is a member of each of the candidate groups. In one embodiment, the set of candidate groups may be pre-determined or determined based on explicit indications of group membership, such as organizational information indicating all of the project teams within a company for which the group member belongs. In these embodiments, group-determination logic 230 can include logic for determining a particular group from the set of candidate groups, for which group information is to be provided to a user. For example, the particular group may be determined based on user data associated with the user for which group data is to be presented, such as data that indicates that user’s context or intent. In some instances, group-determination logic 230 includes instructions for using data associated with a particular user to determine the most likely group out of a set of candidate groups for which to present group information to the user. Further, in some instances, each group, in a set of candidate groups, may be scored for relevance based on data associated with the user. For example, suppose a particular user receives an email from a group member who is a member of two groups: a member of a project team at a company and also a member of a book club. Suppose that in one situation, the particular user and the group member work for the same company and the email received is a work email with the company domain. Thus, a context for the user’s interaction with the group member comprises a work email. Then, based on the user data associated with the particular user, such as the work email, it may be inferred by group-determiner 260 (using group-determination logic 230) that the user’s intent is most likely to be provided with group information about the project team and not information about the book club. In some embodiments, if it is known or determined that the group member is a member of the project team and the book club, then group-determination logic 230 may include logic for determining that the project team has a higher relevance to the particular user because the project team comprises members at the user’s work organization, and the user is interacting with the group member in a work context (for instance, via a work email). In contrast, the book club group may be determined as having a lower relevance because the context of the user’s interaction does not indicate that the user is interacting with the group member outside of a work context. Accordingly, the particular group determined by group-determiner 260 is the project team.

In some embodiments where a plurality of candidate groups is determined, group-determination logic 230 may include logic for presenting the user with an indication of at least a portion of the candidate groups so that the user may select a particular group for which to be provided information about that group. (Alternatively, another component of system 200, such as group-information item assembler 280 or presentation component 220, may generate and/or present an indication of two or more candidate groups from which the user may select a particular group.) For example, within an organization, where a group member has membership on multiple project teams, a user may be presented with an indication of the multiple teams or of each team, such that the user may select one of the teams for viewing group information about the selected team.

Accordingly, in the embodiments of group determiner 260 using group-determination logic 230, the group-determination logic 230 may take different forms. For example, the group-determination logic 230 may comprise a set of rules (which may include static or predefined rules or may be set based on settings or preferences in a user profile 240 associated with the user or a group profile 290 associated with a group), Boolean logic, decision trees (e.g., random forest, gradient boosted trees, or similar decision algorithms), conditions or other logic, a deterministic or probabilistic classifier, fuzzy logic, neural network, finite state machine, support vector machine, logistic regression, clustering, machine learning techniques, similar statistical classification processes, or combinations of these.

Data associated with a group determined by group determiner 260 may be stored in a group profile, such as group profile 290 in storage 225. Similarly, data regarding group members of the group, determined by group-determiner 260, may be stored in group members 292 of a group profile 290. The data in group profiles 250 may be made accessible to the other components of system 200, such as group information item generator 270 and group information items assembler 280.

Continuing with FIG. 2, group information item generator 270 is generally responsible for determining group data for a particular group. Embodiments of group information item generator 270 may generate group data for a group that is determined by group determiner 260. Thus, information about a group for which information items are to be generated may be received from group determiner 260 and/or a group profile 290 in storage 225. Group data determined by group information item generator 270 (or its subcomponents) may be stored in a group profile 290 associated with the group, such as in group data 294, where it may be used by other components or subcomponents of system 200. Alternatively, or in addition, group data determined by group information item generator 270 may be provided to a user, such as a user who is interacting with an indication of the group or indication of a group member. In some embodiments, group data determined by group information item generator 270 (or its subcomponents) comprises a set of one or more group information items, each characterizing an aspect of the group.

Embodiments of group information item generator 270 may determine group data based on: data associated with the group or one or more members of the group; data associated with a particular user, such as a user interacting with an indication of the group or indication of a group member; or a combination thereof. Group information item generator 270 may be provided with data about a particular user and/or data about the group or group members, both of which may be received from or determined from the user data determined by user activity monitor 250, user-data collection component 250, or from one or more user profiles 250, for example. As user data associated with a particular user may be utilized to determine that user’s context or indicate that user’s intent, as described previously, group data that is determined by group information item generator 270 using this user data may be determined based on the user’s context or intent.

Some embodiments of group information item generator 270 utilize group data determination logic 235 to determine group data for presentation to a user. In particular, group data determination logic 235 may comprise computer instructions including rules, conditions, associations, classification models, or other criteria for, among other operations, determining a group information item, determining relevance of an information item to a particular user, scoring or ranking group information items for relevance, or contextualizing a group information item for a user. Group data determination logic 235 may take different forms, depending on the particular information items being determined, contextualized, or processed for relevance, and/or based on user data such as data indicating a context. For example, group data determination logic 235 may comprise a set of rules, such as Boolean logic, various decision trees (e.g., random forest, gradient boosted trees, or similar decision algorithms), conditions or other logic, fuzzy logic, neural network, finite state machine, support vector machine, machine-learning techniques, or combinations of these to determine (or facilitate determining) a group information item according to embodiments described herein.

In some embodiments, the group data determined by group information item generator 270 (which may be determined using group data determination logic 235) is based on explicit or inferred information about the group or group members. For example, group data determination logic 235 may include logic specifying instructions for detecting explicit information about a group, or similarly for inferring group data based on particular user data, such as particular data features or patterns of user data features. Without limitation, examples of explicit information about a group can comprise a charter document regarding the purpose of the group or information regarding group objectives that are explicitly declared. Examples of inferred data associated with a group might comprise user activity related to the group performed by other people, such as file accesses of files related to the group, or, similarly the frequency, rate, or count of file accesses of files related to the group performed by other people. For example, group data determination logic 235 may include logic for determining information about file accesses by non-group members of documents related to the group, such that group information item generator 270 may use the file access information to infer that, based on the document being frequently accessed by other people, a particular document related to the group should be included in the group data for presentation to the user, which may indicate that the document is helpful for understanding the group.

Some embodiments of group data determination logic 235 comprise a plurality of logic for determining various types or categories of group data, and may further include corresponding logic for determining the relevance to a user of group information items from each category. Alternatively, in embodiments without group data determination logic 235, group information item generator 270 may determine one or more categories of group data for presentation to the user. For example, and without limitation, categories of group data determined by group information item generator 270, can comprise: information regarding interactions between the user and the group, such as past communications to one or more group members and to the user or meetings attended by one or more group members and the user; shared connections of people between the user and the group, such as people known by the user and one or more group members; relevant documents, such as documents about the group or related to the group that may be relevant to the user; and/or other insights or information about the group that may be relevant to the user, such as group interests, experience(s), areas of expertise, office location(s), or other information characterizing an aspect of the group. Additionally, the specific group information items in these categories (or another category) may be programmatically generated or determined for relevance to the user according to the group data determination logic 235. An example illustratively depicting a set of group information items determined by group information item generator 270 (which may use group data determination logic 235) is provided in FIG. 4 as group information items 412, 414, 416, and 418.

In some implementations, information item generator 270 may include one or more subcomponents operable to generate group information items according to a category. In particular, a dedicated subcomponent may be used for determining a particular category of group data. Further, in some embodiments, the dedicated subcomponent may utilize group data determination logic 235 that is specific for determining the particular category of group data. For instance, as shown in example system 200, information item generator 270 comprises user-group interactions determiner 272, shared connections determiner 274, group documents determiner 276, group specializations determiner 278, and group insights determiner 279. User-group interactions determiner 272, in general, is responsible for determining group data that comprises interactions between a particular user and the group. The group data may be determined as a group information item indicating one or more user-group interactions. For example, user-group interactions can include, without limitation, past communications to or between one or more group members and to the user, or shared events, such as meetings attended by one or more group members and the user. User-group interactions also may include various types of communications, such as email, chats or chat sessions; meetings that may be online or in person; shared projects between the user and at least one group member; other groups that both the user and one or more group members belong to; shared locations such as office locations, buildings, or floors shared between the user and one or more group members; or other shared interactions. Embodiments of user-group interactions determiner 272 may use user data associated with a user and with one or more group members to determine a user-group interaction. The user data may be received, for example, from user activity monitor 250, user-data collection component 210, or from storage 225, such as from a user profile 240 or group profile 290. Examples of group information items determined by user-group interactions determiner 272 and indicating a user-group interaction are illustratively depicted in item 412 of FIG. 4.

In some embodiments, a plurality of user-group interactions is determined by user-group interactions determiner 272 and may be ranked for relevance to the user so that interactions that are more relevant are provided. For example, as described previously, group data determination logic 235 may be used to determine relevance of an information item to a particular user, as well as for scoring or ranking group information items for relevance. In particular, relevance to a user may be determined based on any number of criteria such as, without limitation, freshness (or how recently an interaction occurred); the number of group members included in the group-user interaction (e.g., an interaction between the user and multiple group members may have higher relevance than an interaction between the user and only one group member); or the importance of the group member in the user-group interaction. For instance, a group member that is a supervisor or manager may have a higher relevance than a group member that is not a supervisor or manager, which may be determined via an organizational chart or user-profile information about the group member.

Shared connections determiner 274, in general, is responsible for determining shared connections of people between or among the user and the group, such as people known by the user and one or more group members. For example, a shared connection might include a non-group member who has worked with the user and at least one member of the group. Embodiments of shared connections determiner 274 can process user data associated with a user and with one or more group members to determine a shared connection. In particular, in some embodiments, user activity data (such as communications data [for instance, patterns of communication], location data, file accesses or shares, relationship data, which may be determined from an organizational chart or contacts list, or other user activity data) is processed to determine a shared connection. For example, user data features may be compared to determine a shared connection, such as by performing a comparison of user data features that comprise information regarding the parties of (or recipients of) a communication among the user and one or more group members. Specifically, a comparison operation can be performed to determine those parties or recipients in common to a communication among the user and one or more group members, which can indicate an instance of a shared connection. The user data, that is utilized by shared connections determiner 274, may be received, for example, from user activity monitor 250 (or a subcomponent, such as features determiner 256), user-data collection component 210, or from storage 225, such as from a user profile 240 or group profile 290.

As described previously, embodiments of shared connections determiner 274 may utilize group data determination logic 235 to determine a group information item. The group information item may comprise an indication of one or more shared connections, such as illustratively depicted in item 414 of FIG. 4. According to one embodiment, shared connections determiner 274 processes user data to determine a shared connection according to the following method. First, a set of one or more people that the user communicates with or interacts with is determined. In some embodiments, the set of people may be ranked based on the number of interactions or communications, or the frequency or rate of interactions or communications between the user and a particular person in the set of persons. Further, some embodiments may consider only communications or interactions within a time duration, such as occurring within the last year or last month, for example. Next, user data for each person in this set of people is processed to determine a communication or interaction with at least one group member. Where at least one communication or interaction is determined, then that person comprises a shared connection between the user and at least one group member. In some embodiments, the number of group members that are included in one of these interactions or communications (between each person in the set of people and at least one group member) is determined, and/or a frequency, rate, or total count of communications or interactions occurring between the person and at least one group member is determined. In these embodiments, the counts, frequencies, rates of interactions or communications, or the number of group members included in an interaction or communication may be used by group data determination logic 235 to determine a shared connection strength or a degree of shared connection. In this way, stronger shared connections can indicate a higher number of interactions between a user and at least one group member, or they can indicate connections between the user and a greater number of group members.

Similarly, according to another embodiment for determining shared connections, shared connections determiner 274 determines a set of people who interact with each group member, and user data for each of those people in the set is processed to determine interactions with a particular user. Where at least one communication or interaction is determined, then that person comprises a shared connection between the user and at least one group member. Some embodiments may further determine the strength or degree of connection as described previously.

According to another embodiment of a method performed by shared connections determiner 274 for determining shared connections with respect to a particular user, a working set of people that the user interacts with may be determined and maintained. For instance, the working set of people may be determined from user data associated with the particular user and stored in user data 244 of a user profile 240 for the particular user. Further, in some implementations, for each person in the working set, information about the interactions is also determined and stored. For instance, the type of interaction (e.g., email, chat, online meeting, or other interaction), counts of interactions with each person, the frequency of interaction, the rate of interaction (e.g., over a time duration such as the number of emails per month between the user and the person in the working set), or similar information about the interactions between the user and each person in the working set may be determined and stored in association with the working set. Next, for each person in the working set for the particular user, a similar working set may be determined for that person, such that each of these working sets corresponds to that person and comprises the people that that person interacts with. In this way, a set of secondary working sets is determined with respect to the user. Next, an intersection operation is performed against the group members for each working set in the set of secondary working sets. In this way, group members who are included in each working set of the secondary working sets can be determined. Where a group member is determined as being included in one of these working sets, the person corresponding to that working set is determined as a shared connection because that person is included in the user’s working set. Further, where multiple group members are determined to be included in one of these working sets, then the person corresponding to that working set may be considered as a shared connection, and the number of group members included in their working set can indicate the strength or degree of the connection. Alternatively, or in addition, in some embodiments a connection strength or degree may be determined as described previously.

In some embodiments, relevance of a group information item indicating a shared connection is determined. For example, as described previously, group data determination logic 235 may be used to determine relevance of an information item to a particular user, as well as for scoring or ranking group information items for relevance. In particular, in some embodiments, where a plurality group information items indicates that shared connections are determined, only a portion of the information items may be provided to the user. For instance, in one embodiment, only the top two or three most relevant information items may be provided. The relevance to a user may be determined based on any number of criteria, such as, without limitation, the connection strength or degree of connection, as described previously. Similarly, relevance may be determined based on the number of group members who are connected with the shared connection or the number of connections that are shared between the person that is the shared connection and the user and the group. For instance, a shared connection who is frequently included in emails with the user and group members could be determined as a stronger connection and thus a more relevant group information item. Relevance also may be determined based on the freshness, or how recently the interaction with a shared connection occurred, or it may be determined based on the importance of the shared connection. For instance, a group member that is a supervisor or manager may have a higher relevance than a shared connection that is not a supervisor or manager, which may be determined via an organizational chart or user-profile information about the group member. Similarly, where the user context or intent indicates that the user may be preparing for an upcoming meeting or event, a shared connection that is attending an upcoming meeting or event may be determined to be more relevant to the user than a shared connection who is not attending the upcoming meeting or event. In some implementations, group data determination logic 235 may weight certain types of interactions for relevance more than others (such as by determining a relevance weight based on the particular interaction), such that shared connections having certain types of shared interactions are determined to be more relevant and thus more likely to be provided to the user as a group information item. For example, an interaction type that comprises attending an in-person meeting together may be assigned a higher relevance weight than an interaction type that comprises a single email sent between the user and the shared connection.

Group documents determiner 276, in general, is responsible for determining documents related to the group. For example, and without limitations, documents related to the group may comprise: files that include information about the group or related to the group, group members, or group activity, such as a charter document or organizational documents about the group; a schedule of events (such as a group calendar); an agenda for a meeting attended by or hosted by the group (or group members), or for which the group (or group members) are invited; a plan, report, or presentation prepared by the group (or group members); a document that group members have interacted with (for example, a presentation that has been accessed by group members or otherwise interacted with by group members); a file that has been interacted with by the group or group members; or other group-related files or documents such as described herein. Embodiments of group documents determiner 276 can determine a set of one or more documents related to a group so that an indication of the set of group documents can be provided to a user as a group information item. Thus, in some embodiments, a group information item provided to a user may comprise an indication of one or more group documents, such as is illustratively depicted in item 416 of FIG. 4.

Some embodiments of group documents determiner 276 can determine documents related to a group that are relevant to the user, which may be determined using group data determination logic 235 and based on user data associated with the user, as described herein. Accordingly, embodiments of group documents determiner 276 may process user data associated with a group or group members to determine a group document, and may further process user data associated with a particular user to determine relevance of the group document to the user. In particular, in some embodiments, the user data processed by group documents determiner 276 comprises user activity information such as file related activity (e.g., file access, file creation, document comment activity by group members, file-storage location data (such as a file repository associated with the group or group member[s], or other file-interaction information), or communications data such as email, chats, and meeting-related communications. Further, in some embodiments, the user data is processed by group documents determiner 276 to determine interactions with a particular file, such as interactions by the group, group members, or the user. The interactions, such as file-related or communications-related activity described previously, may be used for determining that a particular file is a group document and/or is relevant to the user. The user data may be received, for example, from user activity monitor 250 (or a subcomponent, such as features determiner 256), user-data collection component 210, or from storage 225, such as from a user profile 240 or group profile 290.

According to some embodiments, group documents determiner 276 processes user data to determine a set of one or more candidate group documents. Some embodiments of group documents determiner 276 processes user data using group data determination logic 235. For instance, the set of candidate group documents (or a portion of the set) may be determined based on user data indicating that the group (or group members) has interacted with a document, that the user has interacted with the document, or a combination thereof. Alternatively, or in addition, a set of candidate group documents (or a portion of the set) may be determined based on data explicitly indicating that a document is related to a group, such as data indicating that references to the group, group member names, entities, projects, or topics associated with the group are included in the document, or other explicit data indicating that a document is about a group. From the set of candidate group documents, some embodiments further determine various metadata for the documents, such as data regarding interaction of a particular candidate document by user(s) who are not group members; data indicating details of interactions by group members, such as whether: a document was created by or has been modified by a group member; shared with group members; shared by group members to other non-group members; data indicating interaction details by non-group members, such as access or sharing of a candidate document by non-group members; security or permissions associated with a document; or other metadata regarding a document such as described herein or that may be used for determining that a document is a group documents or relevance of the document to a user. Some embodiments of group documents determiner 276 determine a frequency, rate, or similar degree of interaction with regards to a particular document in the set of documents, which may be used to determine relevance of the particular document. For instance, a candidate group document with metadata indicating that the document was created by a group member and is frequently accessed by non-group members may be used to determine that the particular document is a group document that is relevant to the user. In particular, that document may be determined as likely to be relevant to a user because other non-group members frequently accessed the document. Accordingly, group documents determiner 276 may determine an interference that the user similarly would desire to access the document, and the document may be provided to the user as a group information item.

Some embodiments of group documents determiner 276 determine whether the user has permission or access to particular candidate group documents in the set. For example, metadata of a particular document and user data associated with the user may be compared (or otherwise processed) to determine whether the user has permission to access a file (or whether the user has permission to be presented with an indication of the file). Candidate group documents for which a user does not have permission to be provided with may be removed from the set of candidate documents so that they are not provided to the user. Remaining group documents in the set may be provided to the user, or may be evaluated for relevance to the user such that one or more relevant documents are provided. In particular, in some embodiments, the relevance of these remaining documents is determined such that only relevant group documents (or a portion of the relevant group documents) are provided to the user, for instance, as a group information item as, described previously.

Moreover, as described previously, group data determination logic 235 may be used to determine relevance of an information item to a particular user, as well as for scoring or ranking group information items for relevance. In some embodiments, a relevance of an information item to a user may be determined based on user data associated with the user, which may indicate context or user intent. Thus, for example, where a context indicates the user may be preparing for a meeting, then group documents determiner 276 may determine a set of one or more documents for providing to the user that includes a document related to the meeting, if one exists. For instance, where the user data indicates that a user is accessing an indication of the group via a meeting invite or is accessing an indication of the group during a meeting with the group (such as depicted in connection with item 598 of FIG. 5A), then the relevance of a group document determined by group documents determiner 276 may be based on the relevance of the document to the meeting. So, a document that was attached to a meeting invite received by the group may be determined as being relevant to the user in this particular example context. Similarly, if user data associated with the user indicates that the user has little or no interaction with a particular group (or group members), then it may be inferred that group documents about the group, such as a charter document, plan, or a document frequently accessed by non-group members, may be relevant for providing to the user as group data, whereas if a user has frequently interacted with the group (or group members), such as in the form of recurring meetings with the group, then group documents about the group, like a charter document, may be inferred to be less relevant to the user than, for instance, a document recently produced (or otherwise interacted with) by group members.

Group specializations determiner 278, in general, is responsible for determining specialization information about the group, such as topics of expertise or research, skills, or interests of the group. One example of group information items comprising specializations of a group is illustratively provided in item 418 of FIG. 4. Embodiments of group specializations determiner 278 determine explicit group specializations or infer group specializations, and generate a group information item comprising an indication of one or more group specializations. In particular, a group specialization may be determined based on an explicit indication provided by the group or a group member. For instance the group (or a group administrator) may create a list of topics or specify content for which the group has expertise or is focused on.

Group specialization also may be inferred by group specializations determiner 278. For example, a group member (or group administrator, or another person) may specify a set of content, such as one or more documents related to a specialization of the group, from which group specializations determiner 278 may determine group specializations. Similarly, group documents determined by group documents determiner 276 may be used by group specializations determiner 278 to infer group specializations. Some embodiments may use user data for group members, such as user activity data (e.g. communications, documents created or modified, or online activity such as browser activity, for instance) to determine a set of content from which group specializations determiner 278 can infer group specializations. Once a set of content is determined, according to an embodiment, group specializations determiner 278 may perform a topic analysis operation (or topic detection, topic modeling, or topic extraction) to determine a set of one or more topics from the content. In some embodiments, the topic(s) determined from the topic analysis are determined as group specializations for the group. In other embodiments, the frequency or recency of topic(s) determined by the topic analysis may be determined such that those topics occurring frequently or recently are determined as group specializations.

In some embodiments, a computer application or service for identifying topics associated with particular people may be used to determine topics associated with members of the group. From those topics associated with group members, group specializations may be determined. For instance, the set of topics determined to be associated with group members may comprise the group specializations. Alternatively, from a set of topics determined to be associated with group members, those topics occurring most often may be determined as group specializations. One such example of a computer application or service for identifying topics associated with particular people is Microsoft Viva™ Topics.

In some embodiments, a group information including an indication of a particular group specialization may be linked to a reference or content supporting the specialization. For example, upon a user clicking on the information item regarding a particular group specialization, such as a topic for which the group has expertise, the user may be directed to (or presented with) one or more documents created by, curated by, or associated with the group (or a group member) about that topic. Similarly, clicking on the topic may initiate a query of documents about that topic by one or group members.

Some embodiments of group specializations determiner 278 can determine group specializations that are relevant to a user, which may be determined using group data determination logic 235 and based on user data associated with the user, as described herein. For example, group specializations that are relevant to a user may comprise specializations that are similar to the user’s specializations or specializations that are similar to topics occurring in recent user activity performed by the user. In one embodiment, one or more specializations of the user may be determined and compared to the group specialization(s) to determine relevance. The user’s specializations may be determined in a manner similar to the determination of group specializations described previously, such as by inference or explicit declaration. Group specializations that are relevant to the user may be determined based on similarity or relatedness of the specializations from the comparison. In some embodiments, a relational knowledge graph may be utilized to determine relatedness or similarity of topics of the specializations.

In another embodiment, relevance may be determined by processing recent user activity in order for the user to determine one or more topics occurring in the user activity. For example, user activity data (e.g. communications, documents created or modified, or online activity such as browser activity, for instance) over the last month or week may be used to perform topic analysis to identify topics occurring in the recent user activity. From these topics occurring in the recent user activity, a comparison may be performed against group specializations, as described previously, to determine relevant group specializations for providing to the user.

Group insights determiner 279, in general, is responsible for determining insights about the group, such as information about the group that may be relevant to the user. Examples of insights determined by group insights determiner 279 may comprise, without limitation: information about languages spoken by the group; a location of the group (e.g., members of this group are located in Norway); information regarding composition of the group (e.g., all members of this group are in sales, sixty percent of this group is in sales, or forty percent of this group is in technology support, or all members of this group have PhDs); performance outcomes of the group, such as sales figures, projections, or past accomplishments by the group; or other information items that provide insight about the group. Embodiments of group insights determiner 279 may determine insights about a group based on explicit insights provided by the group or group members, or these insights may be inferred. For example, in one embodiment, an insight may be determined based on comparing information about a user with information about group members (using user data associated with the user and with the group or group members) to identify one or more similarities, and then providing the similar information as an insight.

As described herein, some embodiments of group information item generator 270 may use group data determination logic 235 to determine relevance of group data with respect to a particular user, and further may determine a relevance weight for a particular group information item. Relevance weights of group information items may be used to determine which group information items to provide to a user. (For example, as further described herein, some embodiments of group information items assembler 280 determine specific group information items to be provided based on their corresponding relevance weight.) For instance, according to some embodiments, a set of group information items may be determined by group information item generator 270 (or its subcomponents) to be potentially provided to a user. Then, for each group information item in the set (or for a subset of one or more of the group information items in the set), a relevance weight may be determined and used for inferring relevance of an information item to the user such that a high weighting (or, conversely, a low weighting) indicates higher (or lower) relevance. Embodiments of group information item generator 270 or group data determination logic 235 may use user data associated with a particular user to determine the relevance of a group information item to the user, which may be represented as the relevance weight associated with the group information item.

In some embodiments, a relevance weight of an information item may be determined, for example and without limitation: based on the particular type or category of group information item; based on user history, such as whether the user has previously been presented (or engaged) with a particular group information item; and/or based on settings or preferences, which may be configured by the user, a group member, or an administrator, such as user configurations/settings 246 in a user profile 240 or group configurations/settings 296 in a group profile 250. As a non-limiting example, where the group information item indicates a group document, a relevance weight may be determined based at least in part on properties of the group document or metadata of the group document. For instance, a modification or creation date of the group document may be used to indicate how fresh or stale the group document is. Similarly, the file name of the document may indicate its association with the group or relevance to the user, such as where the file name indicates that the file is a charter document for the group. Furthermore, information about how often the group document is accessed by non-group members and/or who is accessing the group document may be determined and used to indicate relevance to the user. For instance, as described previously, a document frequently accessed by non-group members may indicate that the document would be relevant to the user and thus should be determined to have a higher relevance, as reflected in its weighting, so that it is more likely to be included among the information items that are provided to the user. As another example, where group information items comprise indications of user-group interaction between the user and the group, such as email received by or communicated between the user and at least one group member, a group information item indicating an email received by or communicated between the user and a plurality of group members may have higher relevance (and thus have a higher relevance weight) than an email received by or communicated between the user and only one group member.

Continuing with example system 200 and in reference to FIG. 2, group information item assembler 280 is generally responsible for assembling, formatting, or preparing group data for presentation to a user. In particular, embodiments of group information item assembler 280 may determine a set of particular group information items to provide to a user, an amount of group data provided, and/or the presentation or formatting of the group data provided to the user. The group data may be received from group information item generator 270 (or its subcomponents) or from a group profile 290, such as from group data 294. In some embodiments, user data associated with a particular user, which may indicate that user’s context and/or intent when interacting with a group, may be used by group information item assembler 280 to determine and assemble a set of group information items for the user. Thus, group information item assembler 280 also may receive user data for a user, which may be received from user activity monitor 250 (or its subcomponents), user-data collection component 210, or a user profile 240. Further, in some embodiments of group information item assembler 280, the set of particular information items in the group data, the amount of group information provided, and/or the presentation or formatting of the group information that is provided to the user is determined based on the user data associated with the user, such as described herein.

In some embodiments, group information items determined by group information item generator 270 have a corresponding relevance weight. Accordingly, embodiments of group information item assembler 280 can be configured to use the corresponding relevance weight of group information items to rank, prioritize, or filter specific information items of group data for providing to a user. For instance, group information items that have a relevance weight indicating greater relevance to the user (e.g., a higher weight) are more likely to be provided to the user. Further, as described in connection with group information item generator 270, relevance can be determined based on user data, which indicates a user context or intent. Therefore, in some embodiments, group information items provided to a user are provided based on the user context or intent. In this way, group information items generated and provided to a user may be considered to be contextualized for the user.

Some embodiments of group information item assembler 280 are configured to filter group data so that a portion of the group data is provided to a particular user, such as a portion that has greater relevance, as indicated by a determination of relevance (e.g., a relevance weight) of group information items, or a portion that includes diverse types of group information items, or both: a combination of diverse types of group information items and relevant group information items. For example, according to one embodiment, for a set of candidate group information items determined by group information item generator 270, group information item assembler 280 determines the type of group information item (which may be determined, for instance, based on the particular subcomponent of group information item generator 270 that generated the information item). Then, group information item assembler 280 can determine a number of the most relevant information items (e.g. those having the highest relevance weight) for providing to the user, such as the top two or three most relevant information items. In some instances, if fewer group information items exist for a particular type (for example, if there are no group information items indicating shared connections), then more group information items for another type may be determined to be provided to the user.

In some embodiments, the types of group information items to be provided and/or the number of each type of information item provided are determined by group information item assembler 280 based on the context of the user. For instance, as described previously, the user data associated with the user, which indicates the user’s context, can include information indicating a particular computing application being used by the user to access an indication of the group. Thus, the information about the particular computing application may be used by group information item assembler 280 to determine how much group data to provide, and/or which type(s) of group data to provide to the user. For example, if the computing application is an organizational explorer tool such as depicted in FIG. 5C, then group information item assembler 280 may determine to provide a greater amount of group information items and to provide every available type of group information item, as one purpose of the organization explorer tool is to learn about users and groups within an organization. Thus, a user’s intent for using the organization explorer tool to interact with an indication of a group may be to learn about the group, and thus it may be inferred that the user more likely would want to receive a greater amount of group data about the group. In contrast, if the computing application is an email application, such as is depicted in FIG. 5B, then group information item assembler 280 may determine to provide fewer group information items about the group, such as via a small pop-up window (for example, an application window or GUI window) over the email application, for instance. In this way, the user’s email task within the email application is not interfered with by being shown a large volume of information about the group. Further, the fewer group information items provided in the pop-up window may comprise the most relevant group information items to the user’s context, which may be determined based on their corresponding relevance weight.

Similarly, in some instances, group data (or a portion thereof) may be formatted by group information item assembler 280 for presentation to the user based on a particular computing application being used by the user to access an indication of the group. For example, where a first user context comprises the user interacting with an indication of the group in an online meeting application during a meeting (for instance, the user hovers their cursor over an indication of one or more group members who are attendees of the meeting, such as depicted in FIG. 5A), the user may be presented with a Live Persona Card (or similar pop-up profile) for the group that includes a first set of information items about the group. In contrast, where a second user context comprises the user interacting with an indication of the same group via an organization explorer tool (for instance, the user accesses, via an organizational explorer application, a company profile page of a group member such as depicted in FIG. 5C), then the user may be presented with a second set of information items about the group. In particular, the first and second set of group information items may be different for the same user interacting with the same group because of the differences in first and second user contexts. For instance, in this example the first set of group information items may comprise fewer information items due to size constraints of a Live Personal Card presented within the online meeting application; whereas the second set of information items may comprise a greater number of information items than the first set due to the organizational explorer application having a GUI with a greater area for presentation of information items than the Live Persona Card.

Some embodiments of group information item assembler 280 may assemble or format the group data for consumption by a computing application or service. For example, as described previously, group information item assembler 280 may determine a set of group information items for a particular computing application. Some embodiments of 280 use or generate presentation logic to specify the formatting of group information items, or to facilitate the formatting or presentation of group information items to a user via a computing application or service. For example, presentation logic may specify to present a set of relevant group information to a user via a meeting application for three minutes at the beginning of a meeting when the user enters the meeting, or to rotate/alternate displaying a set of information items every thirty seconds. Similarly, presentation logic may specify presentation format(s), such as via a Live Persona Card (or similar pop-up profile), as in the examples illustratively depicted in FIG. 5A as item 520 and in FIG. 5B as item 540. In another example, presentation logic (or group information item assembler 280) may specify surfacing particular group data as a highlighted format. For instance, at the beginning of a meeting with a group (or group members), a user may be presented with a highlight comprising a group information item, such as a group insight, indicting the time zone or location of the group. This may be helpful for the user to know if, for instance, the user’s context indicates that it is daytime (or business hours), but it is nighttime at the group’s location. The assembled, prepared, or formatted group information items determined by group information item assembler 280 may be provided to presentation component 220 for presentation to a user or provided for consumption to a computing application or service to enable other enhanced computing experiences for a user.

Example system 200 also includes storage 225. Storage 225 generally stores information including data, computer instructions (e.g., software program instructions, routines, or services), logic, profiles, and/or models used in embodiments described herein. In an embodiment, storage 225 comprises a data store (or computer data memory). Further, although depicted as a single data store component, storage 225 may be embodied as one or more data stores or may be in the cloud.

As shown in example system 200, storage 225 includes group-determination logic 230 and group data determination logic 235, as described previously. Storage 225 also includes an example embodiment of a user profile 240 and a group profile 290. Example user profile 240 includes information about user accounts and devices 242, user data 244, and user configurations/settings 246. In some embodiments, the information stored in user profile 240 may be available to other components of example system 200.

User accounts and devices 242 generally includes information about user devices accessed, used, or otherwise associated with a user, and/or information related to user accounts associated with the user, which may be used for accessing or collecting user data for a user (such as a user interacting with a group or a group member). For example, information of user accounts and devices 242 may comprise: online or cloud-based accounts (e.g., email, social media) such as a Microsoft® MSA account or a Microsoft 365 account; other accounts such as entertainment or gaming-related accounts (e.g., Xbox®, Netflix®, online game subscription accounts, or similar account information); people data that relates to such accounts, such as user emails, texts, instant messages, calls, other communications, and other content; social network accounts and data, such as news feeds; online activity; and calendars, appointments, application data, other user accounts, or the like. Some embodiments of user accounts and devices 242 may store information across one or more databases, knowledge graphs, or data structures. As described previously, the information stored in user accounts and devices 242 may be determined from user-data collection component 210 or user activity monitor 250 (including one or more of its subcomponents).

As described previously, user data 244 generally includes information about a user, who may be associated with the user profile 240. User data 244 may include user data received from user-data collection component 210 or user data determined by user activity monitor 250 (or its subcomponents), which may include user-related activity data, a context or contextual information, and user data features (or structured or semi-structured user data), in some embodiments. User data 244 also may include information regarding a user’s membership in particular groups, such as the groups determined by group determiner 260, in some embodiments, and/or may include information regarding group information items for a particular group that have been presented to a user, such as may have occurred during past interactions with the group or group members by the user. User data 244 also may include information regarding the user’s interactions with one or more particular groups, such as the number of interactions, frequency, or other data regarding the interactions, shared connections between the user and group(s), or group documents about one or more particular groups that are relevant to the user, in some embodiments.

User configurations/settings 246 generally include user settings or preferences associated with embodiments described herein. By way of example and not limitation, such settings may include user configurations or preferences about the various thresholds described herein, confidence values associated with inferences, explicitly defined settings regarding user data that may be used to determine a group or group data, preferences regarding group data that is provided to the user or information about the user that may be shared (e.g., as group data), preferences or configurations regarding the presentation of group data to the user or consumption of group data by computing applications and services used by the user, or other preferences or configuration settings for any of the embodiments described herein.

Example group profile 290, in general, comprises information about a particular group, such as a group determined by group determiner 260. As shown in example system 200, group profile 290 includes information regarding group members 292, group data 294, and group configurations/settings 246. The information stored in group profile 290 may be available to other components of example system 200, in some embodiments.

Group members 292 includes information regarding membership of the group. For example, the information of group members 292 may comprise a list, roll, database, or similar data regarding people that are members of a particular group. As described previously, the information stored in group members 292 may be determined by group determiner 260. In some embodiments, the information of group members 292 may include an identification of the group members, such as user identification information (e.g., a user ID), name, or other indication for identifying a particular person who is a member of the group. In some embodiments, a person included in group members 292 has a corresponding user profile 240, which may be used for storing or accessing information about that person as a group member.

As described previously, group data 294 generally includes information about the group, such as the group data determined by group information item generator 270 or its subcomponents. Group data 294 also may comprise information about projects, tasks, or objectives associated with the group, information regarding group documents about the group, group specializations, and/or group insights, any of which may be explicitly defined or inferred by group information item generator 270 or its subcomponents. Group data 294 also may comprise a group identifier (e.g., a group ID) for the group, one or more group names, which may include a common name(s) used to refer to the group, or similar identifier information for the group. For example, common group names or a group identifier may be used for named entity recognition or entity extraction by some computing applications or services, thereby providing another enhanced computing experience. This is particularly advantageous in situations where a group has been inferred (for instance, by group determiner 260) and now can be recognized and processed, such as by using named entity recognition, by various computing applications or services. For example, a task manager may use a reference to the group in an email, or a meeting assistance service may use a reference to the group in a meeting transcription to determine the specific group (e.g., via named entity recognition) in order to access information about the group (e.g., from group profile 290) and provide an enhanced computing experience. For instance, the task manager may automatically generate a reminder to a group or group member about a task, or may automatically monitor a commitment of the task or performance of the task by a group member. Similarly, a meeting assistance service may programmatically generate action items for a group (or group members) based on reference to the group during the meeting.

Group configurations/settings 296 generally include group-related settings or preferences associated with embodiments described herein. By way of example and not limitation, such settings may include group configurations or preferences about the various thresholds described herein, confidence values associated with inferences, such as inferred group documents, specializations, or insights, explicitly defined settings regarding group data that may be used to determine particular group data for providing to a user, preferences regarding group data that may be provided, preferences or configurations regarding the presentation of group data to users, consumption of group data by various computing applications and services, or other preferences or configuration settings for any of the embodiments described herein.

Example system 200 includes a presentation component 220 that is generally responsible for presenting content including aspects of the group data, such as group information items determined by group information item generator 270, and may work in conjunction with group information item assembler 280. The content may be presented via one or more presentation components 816, as described in FIG. 8. Presentation component 220 may comprise one or more applications or services on a user device across multiple user devices or in the cloud. For example, in one embodiment, presentation component 220 manages the presentation of group information items to a user across multiple user devices associated with that user, or may use presentation logic determined by group information item assembler 280. For example, presentation component 220 may determine on which user device(s) content is presented and how or how much content is presented, and may present group data determined by group information item generator 270 or other components of system 200. Presentation component 220 may present group data, including any substitutions, reorganizations, or highlights as directed by presentation logic or by group information item assembler 280. In some embodiments, presentation component 220 can present group data, such as group information items, proactively and dynamically, such as when a user interacts with an indication of a group (or group member) or engages with the group (or group member), or, for instance, where a member of a group joins an online meeting or enters a chat session with the user. For example, presentation component 220 may determine when, whether, and how to present group data based on a context and/or based on presentation logic from group information item assembler 280, which may reflect a context.

Some embodiments of presentation component 220 can determine how many group information items, if any, should be presented to a user. Alternatively, presentation logic may specify for presentation component 220, or group information item assembler 280 may instruct presentation component 220 how many group information items, if any, should be presented to a user. This determination can be made, for example, based upon the user device’s screen size (with potentially more or differently formatted group information items presentable on, for instance, a laptop computer, as compared to a mobile phone) or the surface on which the group information item will be presented (for example, a calendaring application, communication platform, or other application or program) such as described previously. The presentation component 220 can present, via a graphical user interface (“GUI”), in a number of different formats and applications, such as those shown in FIGS. 3, 4, and 5A-5C (discussed further below). Presentation component 220 may also generate user interface features associated with or used to facilitate presenting group information items (such as shown in connection with FIGS. 5A-5C). Such features can include interface elements (such as icons or indicators, graphics buttons, sliders, menus, audio prompts, alerts, alarms, vibrations, pop-up windows, notification-bar or status-bar items, in-app notifications, or other similar features for interfacing with a user), queries, and prompts.

With reference now to FIGS. 3, 4, and 5A-5C, a number of exemplary schematic screenshots from a personal computing device are illustratively depicted, showing aspects of example graphical user interfaces that include presentation of various group data, as described herein. The group data shown in FIGS. 3, 4, and 5A-5C may be determined for a particular group and contextualized for a user, such as described in connection with the components of system 200 of FIG. 2. The example group information items represented in the group data, as well as the formatting, assembly, or presentation may be determined as described in connection with group item assembler 280 and presentation component 220 of FIG. 2.

Turning to FIG. 3, an exemplary schematic screen display 300 is shown, which represents a computing device, such as user device 102n, discussed above with respect to FIG. 1. Screen display 300 is shown having a schematic surface 302, which could be any of a number of different computer programs, applications or other displays on the computing device screen display 300. A smaller display space 304 is shown, which could be, for example, a Live Persona Card (LPC), pop-up window, or other type of GUI element for informational display. Within display space 304, a number of information items are shown including item 305, and group data 310.

In this example, item 305 indicates a particular person of interest, Runa Smith, for which the user of a computing device having screen display 300 is being presented with information. Group data 310 presents to the user information about a group of which the person of interest (Runa Smith) is a member. For example, the user may hover their cursor over an indicator for the person of interest, Runa Smith, who is a member of a group, and be presented with a smaller display space 304, which includes group data for a group of which the person of interest, Runa Smith, is a member. In particular, in some embodiments, an interaction by the user with an indication of a group member on surface 304, such as the user hovering their cursor over an indicator of Runa Smith, may be used for determining or providing group data 310 for the member’s group, as described in connection with group determiner 260 of FIG. 2. Within group data 310, a number of group information items are shown as group information item 312, group information item 314, and group information item 316, each of which may comprise any of the group information items described in connection with group information item generator 270 or other components of system 200 of FIG. 2. In this exemplary screen display 300, the three group information items 312, 314, and 316 that are shown may comprise group information items that are the most relevant to the user (or those group information items having the highest relevance weight) as determined by group information item generator 270 and/or group information item assembler 280. Alternatively, or in addition, the three group information items 312, 314, and 316 that are shown may comprise three different types of group information items that are relevant to the user.

With reference to FIG. 4, another exemplary screen display 400 is shown, which may be presented via a computing device, such as user device 102n, discussed above with respect to FIG. 1. Example screen display 400 depicts a GUI showing aspects of group data 410 (identified in the drawing as “Team Insights”) about a group that is presented in conjunction with a person profile 404 for a group member 405 of the group. Thus the particular person, i.e., group member 405 of person profile 404, is a member of the group for which group data 410 is provided. This example screen display 400 may be presented to a user viewing a person profile 404 page for the group member 405, which may be presented via an organizational explorer application, social media platform accessed via a browser, or a corporate intranet or company profile page (presented in this example as a person profile 404) for the group member 405.

As shown in example screen display 400, group data 410 includes group information items 412, 414, 416, and 418, which may be generated as described in connection with group information item generator 270. Further, the specific information provided via group information items 412, 414, 416, and 418 may be contextualized for the particular user viewing the person profile 404, as described herein, and therefore might be different for another user viewing the person profile 404. For instance, a different user viewing person profile 404 can be presented a different set of group information items 412, 414, 416, and 418 that are relevant to that different user. As further shown in example screen display 400, group information item 412 comprises user-group interactions showing interactions between the user and the group, which may be determined from user-group interactions determiner 272. In the example of group information item 412, the user-group interactions comprise information item 4122 and information item 4124. Group information item 4122 comprises a user-group interaction indicating that the user attended a meeting (referred to in this example as “Quarterly Sales Update Meeting”) with a member of the group Runa Smith. Group information item 4124 comprises a user-group interaction, indicating that the user received an email (identified in this example as “Project Timeline Update”) from group member Aleksander Myrvold. In some embodiments, the user may access the email by clicking on (or otherwise interacting with) group information item 4124, or, similarly, the user may access information about the meeting indicated in group information item 4124, such as the meeting invite, clicking on (or otherwise interacting with) group information item 4122. Group information item 414 comprises shared connections between the group and the user, which may be determined from shared connections determiner 274. In the example of group information item 414, three shared connections are shown indicating three non-group members who have a connection with the user and at least one group member of the group. Group information item 416 comprises group documents about the group that are relevant to the user, which may be determined from group documents determiner 276, and group information item 418 comprises group specializations, which may be determined from group specializations determiner 278. In some embodiments, the user may access a particular group document in group information item 416 by clicking on (or otherwise interacting with) an indication of the group document, or, similarly, the user may access more information about a particular group specialization group information item 418 by clicking on (or otherwise interacting with) an indication of the specialization.

In some embodiments, such as described in connection with group determiner 260, based on a user interaction, such as the user’s navigation to the person profile 404 (in this example), an indication of a group member is determined; here, the indication comprises group member 405. Based on the indication of the group member 405, a group may be determined (e.g. by group determiner 260). Based on the determined group, group data 410 for the particular group may be determined (e.g., by group information item determiner 270), and then assembled for presentation (e.g., by group information item assembler 280) via the screen display 400.

With reference to FIG. 5A, another exemplary screen display 510 is shown, which may be presented via a computing device, such as user device 102n discussed above with respect to FIG. 1. Example screen display 510 depicts a GUI associated with a communications computing application, such as Microsoft Teams®. In particular, screen display 510 depicts a smaller display space 520 showing a set of group data 525. Smaller display space 520 and group data 525 represent an example of a visualization that contextualizes the group data 525 for a user (indicated at item 505) of the communications computing application. The group data 525, in this example of FIG. 5A, comprises group information items 522, 524, and 526, which correspond to a group of meeting attendees, which is indicated in GUI element 514. GUI element 514, in this example embodiment, comprises an indication of a plurality of group members of a particular group, which may comprise attendees of the meeting other than the user 505, namely: Xin, Aleksander, Arve, Eline, and Jeanine.

In the example embodiment of FIG. 5A, smaller display space 520 may be presented to the user based on a user context of the user 505. For instance, here the user context may comprise user data associated with the user 505, such as user activity data, indicating that the user is in an online meeting, facilitated via the communications computing application, and has hovered their mouse pointer 598 over the GUI element 514, which indicates meeting attendees of the online meeting. Accordingly, in this example, smaller display space 520 may be presented in response to the user 595 interacting with a GUI element 514 that comprises an indication of at least one group member of the group for which group data 525 is provided. In particular, according to some embodiments, such as described in connection with group determiner 260, based on a user interaction, such as the user 505 hovering their mouse pointer 598 over GUI element 514, an indication of at least one group member is determined. Here, the indication comprises (or is determined from) GUI element 514, which indicates a plurality of group members. Based on the indication of group members provided by GUI element 514, a group may be determined (e.g. by group determiner 260). In this example, the group comprises the other meeting attendees. Based on the determined group, group data 525 for the group may be determined (e.g., by group information item determiner 270), and then assembled for presentation (e.g., by group information item assembler 280) via smaller display space 520 in screen display 510.

With reference to FIG. 5B, another exemplary screen display 530 is shown, which may be presented via a computing device, such as user device 102n, discussed above with respect to FIG. 1. Example screen display 530 depicts a GUI associated with a communications computing application, such as an email application. In particular, screen display 530 depicts a window 535 of the email application showing an email message 532 from sender 536 Runa Smith, and sent to email recipients identified by an email alias 534 for a particular project team. Screen display 520 further depicts a smaller display space 540 showing a group 545 and corresponding group data 550 for the group 545. The group data 545 includes a number of group information items 552, 554, and 556.

Smaller display space 540, group 545, and group data 550 represent another example of a visualization that contextualizes group data 550 for a user of the email application. The group data 550, in this example of FIG. 5B, comprises group information items 522, 524, and 526, which correspond to the group 545, which is indicated via the project team email alias 534. Thus, project team email alias 534, in this example embodiment, comprises an indication of a plurality of group members of a particular group; here, this is the “project team” identified in group 545.

In the example embodiment of FIG. 5B, smaller display space 540 may be presented to the user based on a user context of the user. For instance, here the user context may comprise user data associated with the user, such as user activity data, indicating that the user is using an email application and has hovered their mouse pointer 599 over project team email alias 534, which indicates a group. Accordingly, in this example, smaller display space 540, which includes group data 550 in this example, may be presented in response to the user interacting with an indication of a group that is provided via the project team email alias 534. The group data 550 and group 545 correspond to the group indicated by the project team email alias 534. In particular, according to some embodiments, such as described in connection with group determiner 260, based on a user interaction, such as the user hovering their mouse pointer 599 over the email alias 534, an indication of at least one group member is determined. Here, the indication comprises (or is determined from) the project team email alias 534, which indicates group members of the project team. Based on this indication of group members provided by email alias 534, a group can be determined (e.g. by group determiner 260). In this example, the group comprises the project team identified in group 545. Based on this determined group, group data 550 for the group may be determined (e.g., by group information item determiner 270), and then assembled for presentation (e.g., by group information item assembler 280) via smaller display space 540 in screen display 530.

With reference to FIG. 5C, another exemplary screen display 560 is shown, which may be presented via a computing device, such as user device 102n, discussed above with respect to FIG. 1. Example screen display 560 depicts a GUI associated with an organizational explorer application, such as Org Explorer by Microsoft®. In particular, example screen display 560 depicts a person profile 564 for a particular person of interest 565 provided by the organizational explorer application. Example screen display 560 further depicts a group data window 570 including various group information items 572, 574, and 576. Group data window 570 represents another example of a visualization that contextualizes group information items 572, 574, and 576 for a user of the organizational explorer tool. The group of people for which the group information items 572, 574, and 576 correspond to is a group of which the person of interest 565 is a member. Thus, person profile 564 provides an indication of a group member that is used to determine the group for which group information items 572, 574, and 576 are provided. In some embodiments, the group members may be shown to the user upon the user clicking (or otherwise interacting with) item 575. Other embodiments (not shown) may provide an indication to the group members, such as within or adjacent to group data window 570, similar to the presentation of group 545 in FIG. 5B.

In the example embodiment of FIG. 5C, the specific group information items 572, 574, and 576 may be presented to the user based on a user context of the user. For instance, here the user context may comprise user data associated with the user, such as user activity data, indicating that the user is using organization explorer application and is viewing a person profile 564 of a particular person of interest 565. As the person of interest 565 is a member of a group, person profile 564 provides an indication of at least one group member of the group (e.g., the person of interest 565). Accordingly, as described in connection with group determiner 260, based on a user interaction, such as the user navigating to the person profile 564, an indication of at least one group member is determined. Here, the indication comprises (or is determined from) the person profile 564 of the person of interest 565, who is a member of the group. Based on this indication of the group member, namely the person of interest 565, a group can be determined (e.g. by group determiner 260). Based on this determined group, group information items 572, 574, and 576 may be determined (e.g., by group information item determiner 270), and then assembled for presentation (e.g., by group information item assembler 280) via smaller display space 540 in screen display 530. Moreover, the particular group information items 572, 574, and 576 provided to the user may be determined based on relevance to the user, such as described in connection with group information item generator 270.

Turning now to FIGS. 6 and 7, aspects of an example process flows 600 and 700 are illustratively depicted for some embodiments of the disclosure. Process flows 600 and 700 each may comprise a method (sometimes referred to herein as method 600 and method 700) that may be carried out to implement various example embodiments described herein. For instance, process flow 600 or process flow 700 may be performed to programmatically determine contextualized group data for a user by processing user data, which may be used to provide any of the improved electronic communications technology or enhanced user computing experiences described herein.

Each block or step of process flow 600, process flow 700, and other methods described herein comprises a computing process that may be performed using any combination of hardware, firmware, and/or software. For instance, various functions may be carried out by a processor executing instructions stored in memory, such as memory 812 described in FIG. 8 and/or storage 225 described in FIG. 2. The methods may also be embodied as computer-usable instructions stored on computer storage media. The methods may be provided by a stand-alone application, a service or hosted service (stand-alone or in combination with another hosted service), or a plug-in to another product, to name a few. The blocks of process flow 600 and 700 that correspond to actions (or steps) to be performed (as opposed to information to be processed or acted on) may be carried out by one or more computer applications or services, in some embodiments, which may operate on one or more user devices (such as user device 102a), servers (such as server 106), and may be distributed across multiple user devices, and/or servers, or by a distributed computing platform, and/or may be implemented in the cloud, such as described in connection with FIG. 9. In some embodiments, the functions performed by the blocks or steps of process flows 600 and 700 are carried out by components of system 200, described in connection to FIG. 2.

With reference to FIG. 6, aspects of example process flow 600 are illustratively provided for determining data about a group of people, and, in some embodiments, determining such data (or further processing such data) based on a context. In particular, example process flow 600 may be performed to generate a set of group data, which may comprise one or more group information items characterizing the group, or one or more group members, and which may be generated or formatted (or otherwise contextualized) for a particular user, as described in connection with FIG. 2. Contextualization may be based on user data about the user, and, in some instances, the format or amount of group data provided to the user also may be based on user data about the user, such as described in connection with FIG. 2.

At a block 610, method 600 includes determining an indication of a group member of a group of people. Embodiments of block 610 perform operations to determine an indication of a group member or a plurality of group members based on user data associated with a user. In particular, user data for a user may comprise user activity data, which may be utilized to determine a context or intent of the user, such as is described in connection with user activity monitor 250. The user activity data may indicate an interaction between the user and an indication of the group member (or an indication of the plurality of group members). For example, the interaction may comprise the user clicking or hovering their cursor over an indication of the group member, viewing a person profile of the group member, or other interactions with an indication of the group member described herein. The indication may comprise an email address, comment, person profile, identifier, or other indication of the group member, such as described herein.

Some embodiments of block 610 comprise receiving or determining the user data associated with a user (or in some instances, user data associated with group members) as described in connection with user activity monitor 250 and user-data collection component 210 (FIG. 2). Some embodiments of block 610 may utilize one or more sensors, as described previously, configured to provide the user data. Further, in some embodiments, the user data may be converted into structured data or user data features may be extracted so that the structured user data or user data features may be used in the operations of block 610 to determine, among other data, contextual data for the user. Embodiments of block 610 may be carried out using user activity monitor 250 (FIG. 2) and/or group determiner 260 (FIG. 2), in some implementations. Additional details of embodiments of block 610, or for carrying out operations of block 610, are described in connection to FIG. 2, and in particular user activity monitor 250 and group determiner 260.

At a block 620, method 600 includes determining a group of people comprising the group member. Embodiments of block 620 can determine a group of people comprising the group member (or a plurality of group members, where the indication of block 610 indicates a plurality of group members). The group of people may be determined based on the indication of the group member (or the indication of a plurality of group members), determined in block 610. Some embodiments of block 620 operations are performed that further determine the group of people, based on user data of the user (described in block 610), that interacts with the indication of the group member. The user data for this user can indicate (or be used to determine) a context or intent of the user, which may be used at block 610 to determine a particular group. In particular, in some instances, this context or intent may be utilized at block 620 to determine a likely group from a plurality of groups where the group member has membership.

Some embodiment of block 620 may determine the group of people based on an explicit indication of the group membership, or may infer group membership based on user data for the group member or user data associated with the user, of block 620, that interacted with the group member. In some embodiments, block 620 comprises programmatically determining a group of people using an explicit indication of group membership of the group of people. For example, in an embodiment, data associated with the group member of block 610, such as organizational data (e.g., an org chart) may be programmatically scanned according to a set of group-determination logic 230 to determine an explicit indication of group membership.

Alternatively, or in addition, some embodiments of block 620 programmatically determine a group based on inferring group membership from user data associated with the group member. Further, in some embodiments, group-determination logic 230 may be used by block 620 to infer a group. For example, according to one embodiment, a group may be inferred based on determining a manager or person that the group member reports to, determining all other people who report to that manager (or person), and determining the group as the group member, the manager (or person), and the other people reporting to the manager (or person). Similarly, according to another embodiment, a group may be inferred based on determining that the group member has people who report to him or her, and based on determining the group as the group member and the set of people who report to the group member. In some implementations, it may be determined further, from user data associated with the group member, that the group member is an employee or is otherwise associated with an organization, such as a company, and from this determination, a manager of the group member can be determined, or a set of people reporting to the group member can be determined.

Some embodiments of block 610 determine a set of candidate groups, such as those described in connection with group-determiner 260. In some of these embodiments, user data associated with a user (such as the user described in block 610 who interacts with an indication of a group member) is used to determine the group that is likely the most relevant to the user from among the set of candidate groups. For instance, the group that is most likely to be relevant may be determined based on a user context indicated by (or determined from) the user data. In some embodiments, the set of candidate groups may be ranked based on likely relevance to the user, which may be determined using user data associated with the user. Some embodiments of block 620 utilize an embodiment of group-determination logic 230 described in connection with FIG. 2, in order to determine a group. Block 620 may be carried out using an embodiment of group determiner 260 (FIG. 2). Additional details of embodiments of block 620, or for carrying out operations of block 620, are described in connection to FIG. 2, and in particular group determiner 260.

At a block 630, group data is generated for the group of people determined at block 620. The group data may be generated based on the group, user data associated with the group member of block 610 (or another group member), and/or user data of the user (described in block 610) who interacts with the indication of the group member. In particular, embodiments of block 630 may perform operations to generate or determine group data that is relevant to the user, such as group data that is responsive to a context of the user or otherwise contextualized to the user.

The group data generated at block 630 may comprise one or more group information items, with each group information item characterizing an aspect of the group determined at block 620, in some embodiments. Accordingly, in some embodiments, operations performed at block 630 may further determine relevance or group information items with respect to the user (described in block 610) who interacts with the indication of the group member. In some embodiments where relevance is determined, a relevance weight is determined at block 630 for each group information item, and may be used (for instance at block 640) for determining which group information items are provided to the user. For example, as described herein, a relevance weight or relevance to the user may be determined based on the user data associated with the user, as described in connection with group information item generator 270 (FIG. 2) and its subcomponents. In some embodiments, group information items determined at block 630 may be generated as a category or type of group information item, such as, and without limitation, an indication of a user-group interaction, a shared connection, a group document, a group specialization, or a group insight.

Some embodiments of block 630 utilize an embodiment of group data determination logic 235 described in connection with FIG. 2 in order to generate group data for the group of people. Block 630 may be carried out using an embodiment of group information item generator 270 (FIG. 2). Additional details of embodiments of block 630, or for carrying out operations of block 630, are described in connection to FIG. 2, and in particular group information item generator 270.

At a block 640, method 600 provides at least a portion of the group data determined at block 630 for presentation. For example, the group data may be presented on a computing device from which user data associated with a user (described in block 610) is received, such as the computing device used by the user for interacting with the indication of the group member. The group data (or portion of) may be presented as a set of group information items, such as is described at block 630.

Some embodiments of block 640 provide the group data (or portion of) based on user data associated with a user of a computing device on which the group data is presented. As the user data for the user can indicate (or be used to determine) a context or intent of the user, some of these embodiments of block 640 provide the group data (or portion of) according to a user context or an intent of the user. For example, and as further described herein, based on the user data associated with the user, embodiments of block 640 may format or assemble aspects of the group data, such as specific group information items, for presentation. Embodiments of block 640 may also determine to present or not to present specific group information items.

Some embodiments of method 600 at block 640 may determine the assembly or format of group information items according to a presentation logic, or alternatively may generate presentation logic for determining a format for presentation on a computing device. Further, some embodiments of block 640 include generating instructions for presenting a GUI element comprising one of more group information items, such as, by way of example and not limitation, a live person card or a pop-up window (see e.g., smaller display space 520 of FIG. 5A or smaller display space 540 of FIG. 5B), which may be presented in response to a user interaction with an indication of a group member, such as hovering the cursor over the indication. In some embodiments, where a set of candidate groups is determined at block 620, block 640 may cause to present an indication of a second group (or additional groups from the set of candidate groups), such as the second most likely group according to the user context. For instance, in one embodiment the indication of the second group may be presented as a GUI element comprising a selectable indication that the user may select to view group data for that second group.

Some embodiments of block 640 may be carried out using an embodiment of group information item assembler 280 (FIG. 2). Additional details of embodiments of block 640, or for carrying out operations of block 640, are described in connection to FIG. 2, and, in particular, group information item assembler 280. Moreover, several example aspects of group data provided, according to some of the embodiments of block 640, are illustratively depicted in FIGS. 3, 4, and 5A-5C, and described further in connection with these drawings.

With reference to FIG. 7, aspects of example process flow 700 are illustratively provided for, determining and using data about a group of people to provide an enhanced computing experience. Example process flow 700 may be performed to generate a set of group data including one or more group information items that characterize an aspect of the group of people and which may be generated or formatted (or otherwise contextualized) for a particular user, as described in connection with FIG. 2. Contextualization may be based on user data about the user, and in some instances, the format or amount of group information items provided to the user also may be based on user data about the user, such as described in connection with FIG. 2.

At a block 710, method 700 includes receiving user data associated with a user of a computing device. The user data associated with the user may be received from one or more computing devices used by that user and/or from storage associated with that user, such as a user profile 240, described in connection with FIG. 2. Some embodiments of block 710 comprise receiving or determining the user data associated with a user as described in connection with user activity monitor 250 and user-data collection component 210 (FIG. 2). In particular, in some instances user data may be processed to determine other user data, such as interpretive data. For example, the user data may be processed to determine a context associated with the user or to infer the user’s intent. Accordingly, user data received at block 710 can indicate (or be used to determine) a context or intent of the user. Further, in some embodiments of method 700, this user data can be used at block 720 for determining a particular group of people, at block 730 for determining group information items that are relevant to the user, or at block 740 for generating computing instructions and/or for formatting, assembling, or preparing group information items for the user.

Some embodiments of block 710 including using one or more sensors, as described previously, that are configured to determine the user data. For example, a sensor operating on (or associated with) the computing device, which may include a software-based sensor or monitor, may detect certain user data associated with the user, such as data regarding a computing application being used by the user, or other user activity data. Further, in some embodiments, the user data may be converted into structured data and/or user data features may be extracted so that the structured user data or user data features may be used in the operations of block 710 (or other operations of method 700) to determine, for example, and among other data, contextual data for the user.

Some embodiments of block 710 further comprise receiving user data associated with one or more additional users, such as a group member. Alternatively, in some embodiments of block 710, the user data associated with a user may be used to determine additional user data associated with other users, such as a group member. User data associated with a group member may be used at block 730 for determining group data about the group, in some embodiments. Embodiments of block 710 may be carried out using user activity monitor 250 (FIG. 2) in some implementations. Additional details of embodiments of block 710, or for carrying out operations of block 710, are described in connection to FIG. 2, and, in particular, user activity monitor 250.

At block 720, method 700 includes determining a group of people that does not include the user described at block 710. Some embodiments of block 720 comprise operations to determine the group of people based on the user data received at block 710. In particular, user data received at block 710 may be programmatically processed to determine the group. For instance, some embodiments of block 720 determine the group based on an indication of the group or an indication of one or more group members, which may be determined from the user data. Some embodiments of block 720 further determine the group based on a user context, which may be indicated by (or determined from) the user data. In particular, the user data associated with the user may comprise user activity data, which may be utilized at block 720 to determine a context associated with the user or to infer an intent of the user, such as described in connection with user activity monitor 250. Additionally, the user activity data may indicate an interaction between the user and an indication of the group member (or an indication a plurality of group members). For example, the interaction may comprise the user clicking or hovering their cursor over an indication of a group member, viewing a person profile of a group member, or other interactions with an indication of a group member described herein. The interaction may occur within (or in connection with) a computing application that is operating via the computing device described at block 710. The indication may comprise an email address, comment, person profile, identifier, or other indication of a group member, such as described herein.

Some embodiments of block 720 may determine the group of people based on an explicit indication of the group membership, or may infer group membership, such as described in connection with block 620 of method 600 (FIG. 6) and group determiner 260 (FIG. 2). Some embodiments of block 720 determine a set of candidate groups, such as described in connection with group-determiner 260. In these embodiments of block 720, the user data received at block 710 may be used to determine a particular group from the set of candidate groups. For example, the user data may be used to determine a particular group that is likely to be the most relevant group to the user from among the set of candidate groups. For instance, the group that is most likely to be relevant to the user may be determined based on a user context indicated by (or determined from) the user data associated with the user.

Some embodiments of block 720 utilize an embodiment of group-determination logic 230 described in connection with FIG. 2, to determine a group. Some aspects of block 720 may be implemented as an embodiment of block 620 (process flow 600). Block 720 may be carried out using an embodiment of group determiner 260 (FIG. 2). Additional details of embodiments of block 720, or for carrying out operations of block 720, are described in connection to FIG. 2, and in particular group determiner 720.

At block 730, one or more group information items are determined. A group information item determined at block 730 characterizes an aspect of the group of people determined at block 720, and may be determined based at least in part on the user data received at block 710. In particular, some embodiments of block 730 may generate a group information item based on the group, user data associated with a member of the group (which may be determined as described at block 710, in some embodiments), and/or user data associated with the user that is received at block 710.

Some embodiments of block 730 may perform operations to generate or determine group information items that are relevant to the user of block 710, such as group data that is determined according to a context of the user or that is otherwise contextualized to the user. Moreover, in some embodiments of block 730, where group information items are determined to be relevant to the user, a relevance weight is determined for each group information item. The relevance weight may be used (for instance, at block 740) for determining which group information items are provided to the user and/or for generating instructions for presenting the group information items (or a portion of the group information items).

According to some embodiments of method 700, the group information items determined at block 730 may be generated as a category or type of group information item, such as, and without limitation, an indication of a user-group interaction, a shared connection, a group document, a group specialization, or a group insight. In some instances, a plurality of group information items is determined at block 730, comprising at least two different types of group information items. Some embodiments of block 730 utilize an embodiment of group data determination logic 235 described in connection with FIG. 2 in order to determine a group information item for the group of people. Some aspects of block 730 may be implemented as an embodiment of block 320 (process flow 600). Block 730 may be carried out using an embodiment of group information item generator 270 (FIG. 2). Additional details of embodiments of block 730, or for carrying out operations of block 730, are described in connection to FIG. 2, and in particular, to group information item generator 270.

At a block 740, method 700 includes generating computing instructions for presenting the group information items determined at block 730. Some embodiments of block 740 comprise generating computing instructions for presenting a portion of the group information items determined at block 730. The computing instructions may comprise (or be determined according to) presentation logic, such as is described in connection with group information item assembler 280 in FIG. 2. For example, the computing instructions may specify generating a GUI element for presentation on the computing device of block 710. The GUI element may include the group information items (or a portion of the group information items) determined at bloc 730. The computing instructions may further comprise logic for presenting the group information items (or a portion of the group information items), for example, presenting the GUI element, including the group information items, at the beginning of a meeting with the group or in response to a user interaction with an indication of a group member, such as hovering the cursor over the indication.

Some embodiments of block 740 determine the portion of group information items to be presented based on the user data received at block 710. For example, a portion of group information items may be determined for presentation based on a user context indicated by (or determined from) the user data. Further, a particular group information item may be formatted based on the context, for instance, aspects of a GUI element may be determined based on the context, such as whether the group information items are presented in a pop-up window or LPC, for instance. (See, e.g., smaller display space 520 of FIG. 5A or smaller display space 540 of FIG. 5B.) Similarly, the amount of group data included in a group information item may be determined based on the context, such as providing less group data where the context indicates that the user may be performing a task such as email, and providing more group data where the context indicates the user is specifically browsing information about the group. Other aspects related to the presentation of the group information items also may be based on a user context, such as for how long to present the group information items; whether to rotate group information items; or whether to present group information items that the user previously has not been presented with, for example.

Some embodiments of block 740 may be carried out using an embodiment of group information item assembler 280 (FIG. 2). Additional details of embodiments of block 740, or for carrying out operations of block 740, are described in connection to FIG. 2, and in particular group information item assembler 280.

At a block 750, method 700 provides the computing instructions and group information items for presentation. In some instances, block 750 comprises providing a portion of the group information items for presentation. The group of information items (or portion of) may be presented based at least in part on the computing instructions, in some embodiments. The group information items (or portion) may be provided for presentation on the computing device described at block 710.

Some aspects of block 750 may be implemented as an embodiment of block 640 (process flow 600 of FIG. 6). Some embodiments of block 750 may be carried out using an embodiment of group information item assembler 280 (FIG. 2) and presentation component 220 (FIG. 2). Additional details of embodiments of block 750, or for carrying out operations of block 750, are described in connection to FIG. 2, and in particular group information item assembler 280 and presentation component 220. Moreover, several example aspects of group information items provided for presentation according to some embodiments of block 750 are illustratively depicted in FIGS. 3, 4, and 5A-5C, and described further in connection with these drawings.

Accordingly, we have described various aspects of technology directed to systems and methods for intelligently processing and presenting, on a computing device, group data that is contextualized for a user. It is understood that various features, sub-combinations, and modifications of the embodiments described herein are of utility and may be employed in other embodiments without reference to other features or sub-combinations. Moreover, the order and sequences of steps shown in the example methods 600 and 700 are not meant to limit the scope of the present disclosure in any way, and in fact, the steps may occur in a variety of different sequences within embodiments hereof. Such variations and combinations thereof are also contemplated to be within the scope of embodiments of this disclosure.

### OTHER EMBODIMENTS

In some embodiments, a computerized system to determine contextualized data about a group of people is provided, such as the computerized system described in any of the embodiments above. The computerized system comprises at least one processor, and computer memory having computer-readable instructions embodied thereon, that, when executed by the at least one processor, perform operations. The operations comprise receiving user data associated with a user, and based on the user data, determining an indication of at least one group member of the group of people. The operations may further comprise, based at least on the indication of the at least one group member, determining the group of people comprising the at least one group member. The operations may further comprise determining one or more group information items for the group of people, based on the user data, the one or more group information items each characterizing an aspect of the group of people. The operations may further comprise causing to present at least a portion of the one or more group information items. For example, at least a portion of the one or more group information items may be presented on a user computing device. Advantageously, these and other embodiments, as described herein improve existing computing technologies by providing new or improved functionality in computing applications including automated computing for programmatically determining, contextually surfacing, and/or utilizing certain data characterizing aspects of a group of users, such as contextual data, thereby enhancing the user computing experience. In particular, by determining and processing group data differently than conventional technology, embodiments of this disclosure enable the provision of new functionality for electronic communications computing applications, as well as improved efficiency for electronic communication, enriched electronic communications, and improved computing experiences for users, such as personalized computing experiences. For example, in some embodiments, the operation of a computer application, such as a communications application, is configured or modified to execute different computer instructions than conventional technologies. The different computing instructions include programmatically determining, contextually surfacing, and/or utilizing the group data, such as presenting a new GUI element comprising a set of group information items (or a portion thereof), in response to the computer detecting certain user interactions with the computer, such as the user interacting with an indication of the group via the computing application.

Similarly, existing computing technologies are improved by providing enhanced functionality for communication and collaborative computing applications, improved meeting-scheduling computer services and electronic-messaging applications, determining groups based upon a context, generating and presenting new data types such as group data, and determining, according to a context, certain portions of the group data and/or formatting of the group data for providing to a user or for presentation on a user computing device. Thus existing computing technologies are further improved by enabling improved control over the processing of contextualized group data on computing devices. Further still, these and other embodiments, as described herein improve existing computing technologies by enabling certain group data to be programmatically determined, surfaced or utilized by computing applications without requiring computer tools and resources for a user to manually perform operations to produce this outcome. In this way, some embodiments, as described herein, reduce or eliminate a need for certain databases, data storage, and computer controls for enabling manually performed steps by an administrator, to search, identify, assess, and configure (e.g., by hard-coding) specific, static group data to be presented to users, thereby reducing the consumption of computing resources.

In any combination of the above embodiments of the system, the user data comprises user activity data including an interaction with the indication of the at least one group member.

In any combination of the above embodiments of the system, the indication of the at least one group member comprises an email address, a person profile, or an identifier of the at least one group member that is associated with one of a: meeting, chat session, communication, document comment, activity log, or social-media post.

In any combination of the above embodiments of the system, the group of people is further determined based on the user data.

In any combination of the above embodiments of the system, the group of people is programmatically determined using an explicit indication of group membership of the group of people.

In any combination of the above embodiments of the system, the group of people is programmatically determined by inferring group membership from data associated with the at least one group member.

In any combination of the above embodiments of the system, inferring group membership comprises: programmatically determining a manager who the at least one group member reports to; programmatically determining a set of people who report to the manager, including the at least one group member; and determining the group of people as the manager and the set of people who report to the manager.

In any combination of the above embodiments of the system, inferring group membership comprises: programmatically determining a set of people who report to the at least one group member; and determining the group of people as the at least one group member and the set of people who report to the at least one group member.

In any combination of the above embodiments of the system, a plurality of group information items is determined and wherein each group information item is weighted for relevance to the user based on the user data.

In any combination of the above embodiments of the system, the one or more group information items comprise: an indication of a user-group interaction, a shared connection, a group document, a group specialization, or a group insight.

In any combination of the above embodiments of the system, the user data indicates a user context, and: the one or more group information items are determined based on the user context; or the operations further comprise formatting of the one or more group information items based on the user context.

In any combination of the above embodiments of the system, the at least a portion of the one or more group information items are caused to be presented via a user computing device, and wherein the user data associated with the user is received from the user computing device.

In some embodiments, a computer-implemented method to process data about a plurality of people to provide an enhanced computing experience is provided. The method comprises receiving user data associated with a user of a computing device and programmatically processing the user data to determine a group of people that does not include the user. The method further comprises programmatically determining one or more group information items for the group of people, based on the user data, the one or more group information items each characterizing an aspect of the group of people. The method further comprises generating computing instructions for presenting at least a portion of the one or more group information items. The method further comprises providing the computing instructions and the at least a portion of the one or more group information items for presentation on the computing device. Advantageously, these and other embodiments, as described herein improve existing computing technologies by providing new or improved functionality in computing applications including automated computing for programmatically determining, contextually surfacing, and/or utilizing certain data characterizing aspects of a group of users, such as contextual data, thereby enhancing the user computing experience. In particular, by determining and processing group data differently than conventional technology, embodiments of this disclosure enable the provision of new functionality for electronic communications computing applications, as well as improved efficiency for electronic communication, enriched electronic communications, and improved computing experiences for users, such as personalized computing experiences. For example, in some embodiments, the operation of a computer application, such as a communications application, is configured or modified to execute different computer instructions than conventional technologies. The different computing instructions include programmatically determining, contextually surfacing, and/or utilizing the group data, such as presenting a new GUI element comprising a set of group information items (or a portion thereof), in response to the computer detecting certain user interactions with the computer, such as the user interacting with an indication of the group via the computing application.

Similarly, existing computing technologies are improved by providing enhanced functionality for communication and collaborative computing applications, improved meeting-scheduling computer services and electronic-messaging applications, determining groups based upon a context, generating and presenting new data types such as group data, and determining, according to a context, certain portions of the group data and/or formatting of the group data for providing to a user or for presentation on a user computing device. Thus existing computing technologies are further improved by enabling improved control over the processing of contextualized group data on computing devices. Further still, these and other embodiments, as described herein improve existing computing technologies by enabling certain group data to be programmatically determined, surfaced or utilized by computing applications without requiring computer tools and resources for a user to manually perform operations to produce this outcome. In this way, some embodiments, as described herein, reduce or eliminate a need for certain databases, data storage, and computer controls for enabling manually performed steps by an administrator, to search, identify, assess, and configure (e.g., by hard-coding) specific, static group data to be presented to users, thereby reducing the consumption of computing resources.

In any combination of the above embodiments of the method, programmatically processing the user data to determine a group of people that does not include the user comprises determining from the user data, user activity data indicating a user interaction with an indication of the group of people or an indication of at least one group member.

In any combination of the above embodiments of the method, the user interaction occurs within a computing application operating on the computing device, and the computing instructions comprise generating a graphical user interface (GUI) element to present, within the computing application, the at least a portion of the one or more group information items, thereby providing an enhanced computing experience.

In any combination of the above embodiments of the method, the user data indicates a user context, and the method further comprises: programmatically determining the one or more group information items based on the user context; or determining the at least a portion of the one or more group information items to be presented, based on the user context.

In any combination of the above embodiments of the method, each of the one or more group information items comprises a type of group information item, and the types of group information items include: an indication of a user-group interaction, a shared connection, a group document, a group specialization, and a group insight.

In any combination of the above embodiments of the method, a plurality of group information items for the group of people are programmatically determined, and the plurality of group information items comprises different types of group information items.

In some embodiments, one or more computer storage media having computer-executable instructions embodied thereon that, when executed by at least one computer processor, cause computing operations to be performed. The operations comprise receiving user data associated with a user, and based on the user data, determining an indication of at least one group member of the group of people. The operations further comprise based at least on the indication of the at least one group member, determining the group of people comprising the at least one group member. The operations further comprise determining a plurality of group information items for the group of people, based on the user data, each group information item characterizing an aspect of the group of people. The operations further comprise causing to present the plurality of group information items. Advantageously, these and other embodiments, as described herein improve existing computing technologies by providing new or improved functionality in computing applications including automated computing for programmatically determining, contextually surfacing, and/or utilizing certain data characterizing aspects of a group of users, such as contextual data, thereby enhancing the user computing experience. In particular, by determining and processing group data differently than conventional technology, embodiments of this disclosure enable the provision of new functionality for electronic communications computing applications, as well as improved efficiency for electronic communication, enriched electronic communications, and improved computing experiences for users, such as personalized computing experiences. For example, in some embodiments, the operation of a computer application, such as a communications application, is configured or modified to execute different computer instructions than conventional technologies. The different computing instructions include programmatically determining, contextually surfacing, and/or utilizing the group data, such as presenting a new GUI element comprising a set of group information items (or a portion thereof), in response to the computer detecting certain user interactions with the computer, such as the user interacting with an indication of the group via the computing application.

Similarly, existing computing technologies are improved by providing enhanced functionality for communication and collaborative computing applications, improved meeting-scheduling computer services and electronic-messaging applications, determining groups based upon a context, generating and presenting new data types such as group data, and determining, according to a context, certain portions of the group data and/or formatting of the group data for providing to a user or for presentation on a user computing device. Thus existing computing technologies are further improved by enabling improved control over the processing of contextualized group data on computing devices. Further still, these and other embodiments, as described herein improve existing computing technologies by enabling certain group data to be programmatically determined, surfaced or utilized by computing applications without requiring computer tools and resources for a user to manually perform operations to produce this outcome. In this way, some embodiments, as described herein, reduce or eliminate a need for certain databases, data storage, and computer controls for enabling manually performed steps by an administrator, to search, identify, assess, and configure (e.g., by hard-coding) specific, static group data to be presented to users, thereby reducing the consumption of computing resources.

In any combination of the above embodiments, the operations further comprise determining a plurality of group information items based on the user data comprises processing the user data to determine group information items that are relevant to a context of the user.

In any combination of the above embodiments, the plurality of group information items comprise different types of group information items from among group information item types including: an indication of a user-group interaction, a shared connection, a group document, a group specialization, and a group insight.

In any combination of the above embodiments, the operations further comprise the user data is received from a computing device and the plurality of group information items are caused to be presented using the computing device.

### EXAMPLE COMPUTING ENVIRONMENTS

Having described various implementations, several example computing environments suitable for implementing embodiments of the disclosure are now described, including an example computing device and an example distributed computing environment in FIGS. 8 and 9, respectively. With reference to FIG. 8, an exemplary computing device is provided and referred to generally as computing device 800. The computing device 800 is but one example of a suitable computing environment and is not intended to suggest any limitation as to the scope of use or functionality of embodiments of the disclosure. Neither should the computing device 800 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure may be practiced in a variety of system configurations, including mobile devices, consumer electronics, general-purpose computers, more specialty computing devices, or the like. Embodiments of the disclosure may also be practiced in distributed computing environments where tasks are performed by remote-processing devices that are linked through a communications network. In a distributed computing environment, program modules may be located in both local and remote computer storage media including memory storage devices.

Some embodiments may comprise an end-to-end software-based system that can operate within system components described herein to operate computer hardware to provide system functionality. At a low level, hardware processors may execute instructions selected from a machine language (also referred to as machine code or native) instruction set for a given processor. The processor recognizes the native instructions and performs corresponding low level functions relating to, for example, logic, control, and memory operations. Low level software written in machine code can provide more complex functionality to higher levels of software. Accordingly, in some embodiments, computer-executable instructions may include any software, including low level software written in machine code, higher level software such as application software, and any combination thereof. In this regard, the system components can manage resources and provide services for system functionality. Any other variations and combinations thereof are contemplated with thembodiments of the present disclosure.

With reference to FIG. 8, computing device 800 includes a bus 810 that directly or indirectly couples the following devices: memory 812, one or more processors 814, one or more presentation components 816, one or more input/output (I/O) ports 818, one or more I/O components 820, and an illustrative power supply 822. Bus 810 represents what may be one or more buses (such as an address bus, data bus, or combination thereof). Although the various blocks of FIG. 8 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 8 is merely illustrative of an exemplary computing device that can be used in connection with one or more embodiments of the present disclosure. Distinction is not made between such categories as “workstation,” “server,” “laptop,” or “handheld device,” as all are contemplated within the scope of FIG. 8 and with reference to “computing device.”

Computing device 800 typically includes a variety of computer-readable media. Computer-readable media can be any available media that can be accessed by computing device 800 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include, for example, solid-state memory, hard drives, and optical-disc drives. Computing device 800 includes one or more processors 814 that read data from various entities such as memory 812 or I/O components 820. Presentation component(s) 816 presents data indications to a user or other device. Exemplary presentation components include a display device, speaker, printing component, vibrating component, and the like.

The I/O ports 818 allow computing device 800 to be logically coupled to other devices, including I/O components 820, some of which may be built in. Illustrative components include a microphone, joystick, game pad, satellite dish, scanner, printer, or a wireless device. The I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

Some embodiments of computing device 800 may include one or more radio(s) 824 (or similar wireless communication components). The radio transmits and receives radio or wireless communications. The computing device 800 may be a wireless terminal adapted to receive communications and media over various wireless networks. Computing device 800 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (for example, a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Referring now to FIG. 9, an example distributed computing environment 900 is illustratively provided, in which implementations of the present disclosure may be employed. In particular, FIG. 9 shows a high level architecture of an example cloud computing platform 910 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 900 that includes cloud computing platform 910, rack 920, and node 930 (e.g., computing devices, processing units, or blades) in rack 920. The technical solution environment can be implemented with cloud computing platform 910, which runs cloud services across different data centers and geographic regions. Cloud computing platform 910 can implement fabric controller 940 component for provisioning and managing resource allocation, deployment, upgrade, and management of cloud services. Typically, cloud computing platform 910 acts to store data or run service applications in a distributed manner. Cloud computing infrastructure 910 in a data center can be configured to host and support operation of endpoints of a particular service application. Cloud computing infrastructure 910 may be a public cloud, a private cloud, or a dedicated cloud.

Node 930 can be provisioned with host 950 (e.g., operating system or runtime environment) running a defined software stack on node 930. Node 930 can also be configured to perform specialized functionality (e.g., compute nodes or storage nodes) within cloud computing platform 910. Node 930 is allocated to run one or more portions of a service application of a tenant. A tenant can refer to a customer utilizing resources of cloud computing platform 910. Service application components of cloud computing platform 910 that support a particular tenant can be referred to as a multi-tenant infrastructure or tenancy. The terms “service application,” “application,” or “service” are used interchangeably with regards to FIG. 9, and broadly refer to any software, or portions of software, that run on top of, or access storage and computing device locations within, a datacenter.

When more than one separate service application is being supported by nodes 930, nodes 930 may be partitioned into virtual machines (e.g., virtual machine 952 and virtual machine 954). Physical machines can also concurrently run separate service applications. The virtual machines or physical machines can be configured as individualized computing environments that are supported by resources 960 (e.g., hardware resources and software resources) in cloud computing platform 910. It is contemplated that resources can be configured for specific service applications. Further, each service application may be divided into functional portions such that each functional portion is able to run on a separate virtual machine. In cloud computing platform 910, multiple servers may be used to run service applications and perform data storage operations in a cluster. In particular, the servers may perform data operations independently but exposed as a single device, referred to as a cluster. Each server in the cluster can be implemented as a node.

Client device 980 may be linked to a service application in cloud computing platform 910. Client device 980 may be any type of computing device, such as user device 102n described with reference to FIG. 1, and the client device 980 can be configured to issue commands to cloud computing platform 910. In embodiments, client device 980 may communicate with service applications through a virtual Internet Protocol (IP) and load balancer or other means that direct communication requests to designated endpoints in cloud computing platform 910. The components of cloud computing platform 910 may communicate with each other over a network (not shown), which may include, without limitation, one or more local area networks (LANs) and/or wide area networks (WANs).

### ADDITIONAL STRUCTURAL AND FUNCTIONAL FEATURES OF EMBODIMENTS OF THE TECHNICAL SOLUTION

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a computing device or a distributed computing environment; however the computing device and distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1. A computer system to determine contextualized data about a group of people, the system comprising:
at least one processor; and
computer memory having computer-readable instructions embodied thereon, that, when executed by the at least one processor, perform operations comprising:
receive user data associated with a user;
based on the user data, determine an indication of at least one group member of the group of people;
based at least on the indication of the at least one group member, determine the group of people comprising the at least one group member;
determine one or more group information items for the group of people, based on the user data, the one or more group information items each characterizing an aspect of the group of people; and
cause to present at least a portion of the one or more group information items.

2. The system of claim 1, wherein the user data comprises user activity data including an interaction with the indication of the at least one group member.

3. The system of claim 1, wherein the indication of the at least one group member comprises an email address, a person profile, or an identifier of the at least one group member that is associated with one of a: meeting, chat session, communication, document comment, activity log, or social-media post.

4. The system of claim 1, wherein the group of people is further determined based on the user data.

5. The system of claim 1, wherein the group of people is programmatically determined using an explicit indication of group membership of the group of people.

6. The system of claim 1, wherein the group of people is programmatically determined by inferring group membership from data associated with the at least one group member.

7. The system of claim 6, wherein inferring group membership comprises:
programmatically determining a manager who the at least one group member reports to;
programmatically determining a set of people who report to the manager, including the at least one group member; and
determining the group of people as the manager and the set of people who report to the manager.

8. The system of claim 6, wherein inferring group membership comprises:
programmatically determining a set of people who report to the at least one group member; and
determining the group of people as the at least one group member and the set of people who report to the at least one group member.

9. The system of claim 1, wherein a plurality of group information items is determined and wherein each group information item is weighted for relevance to the user based on the user data.

10. The system of claim 1, wherein the one or more group information items comprise: an indication of a user-group interaction, a shared connection, a group document, a group specialization, or a group insight.

11. The system of claim 1, wherein the user data indicates a user context, and wherein:
the one or more group information items are determined based on the user context; or
the operations further comprise formatting of the one or more group information items based on the user context.

12. The system of claim 1, wherein the at least a portion of the one or more group information items are caused to be presented via a user computing device, and wherein the user data associated with the user is received from the user computing device.

13. A computerized method to process data about a plurality of people to provide an enhanced computing experience, the method comprising:
receiving user data associated with a user of a computing device;
programmatically processing the user data to determine a group of people that does not include the user;
programmatically determining one or more group information items for the group of people, based on the user data, the one or more group information items each characterizing an aspect of the group of people;
generating computing instructions for presenting at least a portion of the one or more group information items; and
providing the computing instructions and the at least a portion of the one or more group information items for presentation on the computing device.

14. The computerized method of claim 13, wherein programmatically processing the user data to determine a group of people that does not include the user comprises determining from the user data, user activity data indicating a user interaction with an indication of the group of people or an indication of at least one group member.

15. The computerized method of claim 14, wherein the user interaction occurs within a computing application operating on the computing device, and wherein the computing instructions comprise generating a graphical user interface (GUI) element to present, within the computing application, the at least a portion of the one or more group information items, thereby providing an enhanced computing experience.

16. The computerized method of claim 13, wherein the user data indicates a user context, and:
programmatically determining the one or more group information items based on the user context; or
determining the at least a portion of the one or more group information items to be presented, based on the user context.

17. The computerized method of claim 13, wherein each of the one or more group information items comprises a type of group information item, and wherein the types of group information items include: an indication of a user-group interaction, a shared connection, a group document, a group specialization, and a group insight.

18. The computerized method of claim 17, wherein a plurality of group information items for the group of people are programmatically determined, and wherein the plurality of group information items comprises different types of group information items.

19. Computer storage media having computer-executable instructions embodied thereon, that, when executed by at least one computer processor, cause computing operations to be performed, comprising:
receiving user data associated with a user;
based on the user data, determining an indication of at least one group member of the group of people;
based at least on the indication of the at least one group member, determining the group of people comprising the at least one group member;
determining a plurality of group information items for the group of people, based on the user data, each group information item characterizing an aspect of the group of people; and
causing to present the plurality of group information items.

20. The computer storage media of claim 19:
wherein determining a plurality of group information items based on the user data comprises processing the user data to determine group information items that are relevant to a context of the user;
wherein the plurality of group information items comprise different types of group information items from among group information item types including: an indication of a user-group interaction, a shared connection, a group document, a group specialization, and a group insight; and
wherein the user data is received from a computing device and the plurality of group information items are caused to be presented using the computing device.
